(19) United States
(12) Patent Application Publication
(10) Pub. No.: US 2013/0171397 A1
(43) Pub. Date: Jul. 4, 2013

(54) 2,5-FURAN DICARBOXYLIC ACID-BASED POLYESTERS PREPARED FROM BIOMASS

(71) Applicant: PEPSICO, INC., Purchase, NY (US)

(72) Inventors: Tamal Ghosh, Armonk, NY (US); Kamal Mahajan, White Plains, NY (US); Sridevi Narayan-Sarathy, Frisco, TX (US); Mohamed Naceur Balgacem, Brié et Angonnes (FR); Preetha Gopalakrishnan, Grenoble (FR)

(73) Assignee: PEPSICO, INC., Purchase, NY (US)

(21) Appl. No.: 13/728,286

(22) Filed: Dec. 27, 2012

Related U.S. Application Data
(60) Provisional application No. 61/582,983, filed on Jan. 4, 2012.

(51) Int. Cl. C08G 63/183; B32B 1/02

(52) U.S. Cl. CPC C08G 63/183; B32B 1/02
USPC 428/36.92; 528/302; 528/285

(57) ABSTRACT

Polyesters described herein are prepared in whole or in part from biomass. In one aspect, a copolyester is formed from monomers of 2,5-furan dicarboxylic acid, or a lower alkyl ester thereof, at least one aliphatic or cycloaliphatic C₃-C₁₀ diol, and terephthalic acid. In another aspect, a polyester is formed from monomers of 2,5-furan dicarboxylic acid, or a lower alkyl ester thereof, and isosorbide. In some aspects, the polyester is polyethylene isosorbide furandicarboxylate, poly(2,5-furandimethylene adipate), or polyvanillic ester. The polyesters may have desirable physical and thermal properties and can be used to partially or wholly replace polyesters derived from fossil resources, such as poly(ethylene terephthalate).

### CROSS REFERENCE TO RELATED APPLICATION

This application claims benefit under 35 U.S.C. §119(e) to U.S. Application No. 61/582,983, filed Jan. 4, 2012, the disclosure of which is hereby incorporated by reference in its entirety.

### BACKGROUND

Recently there has been an increased focus on obtaining polymeric materials derived from renewable resources, including both the chemical modification of natural polymers and the use of biomass-based monomers to synthesize new macromolecules. This growing trend is part of a larger strategy aimed at finding replacements to diminishing fossil resources. The concept and applications of the bio-refinery illustrate these global trends. Biomass offers a promising alternative to fossil fuels as a renewable resource, as it can be produced in a carbon-neutral way. To avoid competition for land resources dedicated to food and animal feed production, it is particularly desirable to utilize inedible biomass in the production of polymeric materials. Wood-based biomass offers an abundant resource comprising cellulose (35-50%), hemicellulose (25-30%) and lignin (25-30%). Cellulose and hemicellulose can be depolymerized into monosaccharides, including glucose, fructose and xylose.

### SUMMARY

The use of sugars and/or polysaccharides as precursors to furan derivatives is perhaps one of the most promising realms for the preparation of polymers which could potentially replace current polymers derived from petroleum. Furfural (F) and hydroxymethylfurfural (HMF) are second-generation chemicals obtained from pentoses and hexoses, respectively. F is an abundant chemical commodity which can be manufactured through a relatively simple technology and is used in a wide variety of agricultural and forestry byproducts that are inexpensive and ubiquitous. The natural structures involved in its synthesis are C₅ sugars and polysaccharides, which are present in biomass residues. The present world production of furfural is about 300,000 tons per year. HMF can be obtained from hexoses, and also from F by substituting the C₅. HMF can also be oxidized or reduced to obtain 2,5-furandicarboxylic acid (FDCA) and 2,5-bis(hydroxymethyl)furan (BHMF). FDCA can be esterified by methanol to yield corresponding methyl ester derivative (FDE).

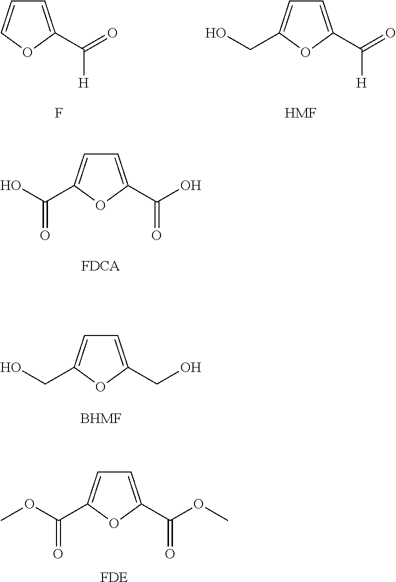

Isosorbide (IS) is also a diol available commercially and originating from vegetal biomass.

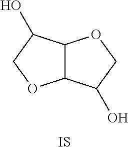

Lignin is the second most abundant polymer from renewable resources. In some aspects, lignin fragments may be used as a source of monomers to synthesize of polymers, by introducing them (lignin as a macro monomer) into formaldehyde-based wood resins or polyurethane formulation. As lignin is produced in colossal amounts in papermaking processes and consumed in situ as a source of energy (energy recovery), a small proportion may be isolated and used as a monomer source, without affecting its primary use as a fuel. Certain papermaking technologies, such as the oraganosolv processes and biomass refinery approaches such as steam explosion, provide lignin fragments with more regular structures. Therefore, lignin macro monomers represent today a particularly promising source of novel materials based on renewable resources. Vanillic acid may be derived from lignin.

In other aspects, vanillic acid (VA) may be used as an A-B-type monomer to prepare novel polyesters originating from vegetal biomass.

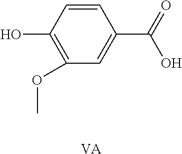

In various aspects of the present invention, different polyesters incorporate furan and/or other aromatic moieties in conjunction with complementary moieties. In one aspect, a copolyester is formed from monomers of (i) 2,5-furandicarboxylic acid, or a lower alkyl ester thereof, (ii) at least one aliphatic or cycloaliphatic C₃-C₁₀ diol, and (iii) terephthalic acid.

In another aspect, a polyester is formed from monomers of 2,5-furan dicarboxylic acid, or a lower alkyl ester thereof, and isosorbide.

In another aspect, a polyester is poly(2,5-furandimethylene adipate).

In another aspect, a polyester is polyvanillic ester.

In yet another aspect, a polyester is polyethylene isosorbide furandicarboxylate.

In some embodiments, a polyester or copolyester is prepared by direct polycondensation. In other embodiments, the polyester or copolyester is prepared by transesterification. Polyesters described herein may have physical and thermal properties similar to or even better than those of poly(ethylene terephthalate), making them useful in a wide variety of applications. In some aspects, polyesters are formed into articles using suitable techniques, such as sheet or film extrusion, co-extrusion, extrusion coating, injection molding, thermoforming, blow molding, spinning, electrospinning, laminating, emulsion coating or the like. In one aspect, the article is a food package. In another aspect, the article is a beverage container. Other applications include, but not limited to, fibers for cushioning and insulating material, oriented films, bi-axially oriented films, liquid crystal displays, holograms, coatings on wood products, functional additives in a polymer blend system. The polyesters described herein may be used either alone or in a blend or mixture containing one or more other polymeric components.

According to another aspect, a method of preparing a 2,5-furandicarboxylic acid based copolyester is disclosed. The method comprises combining 2,5-furandicarboxylic acid or a lower alkyl ester thereof, at least one aliphatic or cycloaliphatic C₂-C₁₀ diol, terephthalic acid, and a catalyst to form a reaction mixture, and stirring the reaction mixture under a stream of nitrogen. The reaction mixture is gradually heated to a first temperature of about 200-230° C. and the first temperature is maintained for about 8 to about 12 hours. The reaction mixture is then gradually heated to a second temperature of about 240-260° C. and the second temperature is maintained for about 12 to about 18 hours. Water is removed from the reaction mixture, and the resulting copolyester is collected. This protocol was found to yield faster reaction times, providing a more efficient and cost effective route to synthesizing the copolyesters.

Polymers from furan-based monomers with different diols and diacids and also polymer from lignin monomer were successfully prepared with the aim of replacing polymers derived from petrochemicals. Poly(butylene 2,5-furandicarboxylate) (PBF) is of particular interest. As a homolog of poly(ethylene 2,5-furandicarboxylate) (PEF), it would be expected that the glass transition temperature (T_{g}) of PBF would be lower than that of PEF. The opposite condition was unexpectedly found to occur, such that the T_{g} of PBF is higher than that of PEF. PBF also has a dramatically lower melting temperature (Tₘ) than that of PEF. A lower Tₘ advantageously enables the material to be processed at lower temperatures. Together these properties of PBF make it highly desirable in food and beverage packaging applications, especially hot-filling of beverages and the like. Also of interest is a copolyester of the PEF polymer with isosorbide (IS) and PBTF. The copolyesters obtained are essentially amorphous polymers. Use of isosorbide as a comonomer is expected to improve mechanical properties of the straight polyester.

### BRIEF DESCRIPTION OF THE DRAWINGS

FIG. 1 shows the FTIR for 2,5-furandicarboxylic acid (FDCA).

FIG. 2 shows the NMR for FDCA in the solvent DMSO.

FIG. 3 shows the DSC for FDCA.

FIG. 4 shows the FTIR for FDE.

FIG. 5 shows the NMR for 2,5-dimethyl furandicarboxylate (FDE) in the solvent CD₃COCD₃.

FIG. 6 shows the NMR for FDE in another solvent, CF₃COOD.

FIG. 7 shows the DSC for FDE.

FIG. 8 shows the FTIR for isosorbide (IS).

FIGS. 9 and 10 show the DSC for IS.

FIG. 11 shows the NMR for 2,5-bis(hydroxymethyl)furan (BHMF) in the solvent DMSO.

FIGS. 12 and 13 show the DSC for BHMF.

FIG. 14 shows the FTIR for vanillic acid (VA).

FIG. 15 shows the NMR for VA in the solvent CD₃COCD₃.

FIG. 16 shows the DSC for VA.

FIG. 17 shows the FTIR for poly(ethylene 2,5-furandicarboxylate) (PEF) synthesized by polytransesterifiation.

FIG. 18 shows the NMR for PEF synthesized by polytransesterifiation in the solvent CF₃COOD.

FIGS. 19 and 20 show the DSC for PEF synthesized by polytransesterifiation.

FIG. 21 shows the FTIR for poly(butylene 2,5-furandicarboxylate) (PBF) synthesized by polytransesterifiation.

FIG. 22 shows the NMR for PBF synthesized by polytransesterifiation.

FIGS. 23 and 24 show the DSC for PBF synthesized by polytransesterifiation.

FIG. 25 shows the FTIR for poly(ethylene 2,5-furandicarboxylate) (PEF) obtained by direct polycondensation.

FIG. 27 shows the DSC for PEF obtained by direct polycondensation.

FIG. 28 shows the FTIR for poly(butylene 2,5-furandicarboxylate) (PBF) obtained by direct polycondensation.

FIGS. 29 and 30 show the NMR for PBF, obtained by direct polycondensation, in the solvent CF₃COOD.

FIGS. 31 and 32 show the DSC for PBF obtained by direct polycondensation.

FIG. 33 shows the FTIR for a polyester synthesized from isosorbide (PIF).

FIG. 34 shows the NMR for PIF in the solvent CF₃COOD.

FIGS. 35 and 36 show the DSC for PIF.

FIG. 37 shows the FTIR for poly(2,5-furandimethylene adipate) (PFA).

FIGS. 38 and 39 show the DSC for PFA.

FIG. 40 shows the FTIR for polyvanillic ester (PVE) collected directly after synthesis.

FIG. 41 shows the FTIR for PVE after purification.

FIG. 42 shows the NMR for PVE collected directly after synthesis in the solvent DMSO.

FIG. 43 shows the NMR for PVE after purification in the solvent DMSO.

FIGS. 44 and 45 show the DSC for PVE.

FIG. 46 shows the FTIR for polyethylene isosorbide furandicarboxylate (PEIF).

FIGS. 47 and 48 show the DSC for PEIF; FIG. 48 shows a melting point at 184° C. for the copolyester with 10% isosorbide.

FIG. 49 shows the FTIR for the copolyester PBTF.

FIG. 50 shows the NMR for PBTF.

FIG. 51 shows the DSC for PBTF.

FIG. 52 shows the x-ray diffraction (XRD) for PEF.

FIG. 53 shows the XRD for PBF.

FIG. 54 shows the XRD for PEIF.

FIG. 55 shows the XRD for PBTF.

FIGS. 57 and 58 show the NMR and DSC, respectively, for PBF synthesized using direct polycondensation.

### DETAILED DESCRIPTION

In various aspects described herein, polyesters may be prepared from biomass, either directly or by synthesizing monomers which are obtained from biomass. The term “polyester” as used herein is inclusive of polymers prepared from multiple monomers that are sometimes referred to as copolyesters. Terms such as “polymer” and “polyester” are used herein in a broad sense to refer to materials characterized by repeating moieties and are inclusive of molecules that may be characterized as oligomers. Unless otherwise clear from context, percentages referred to herein are expressed as percent by weight based on the total composition weight.

Furfural (F) and hydroxymethylfurfural (HMF) may be obtained from pentoses and hexoses, respectively. 2,5-furandicarboxylic acid (FDCA) can be esterified by methanol to yield the corresponding methyl ester derivative (FDE). HMF also can be oxidized or reduced to obtain 2,5-furandicarboxylic acid (FDCA) and 2,5-bis(hydroxymethyl)furan (BHMF):

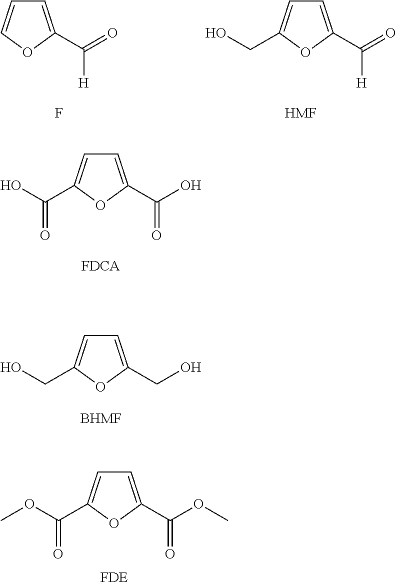

Lignin is the second most abundant polymer from renewable resources. Vanillic acid (VA) may be used as an A-B-type monomer to prepare novel polyesters originating from vegetal biomass.

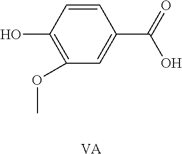

In general, polyesters are prepared by reacting a dicarboxylic acid containing furan and/or other aromatic functionality, and at least one diol. Suitable diols include aliphatic or cycloaliphatic C₃-C₁₀ diols, non-limiting examples of which include 1,4-butanediol, and isosorbide (IS), a commercially available diol which also can be found in various vegetal biomasses.

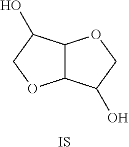

In addition to these monomers, the polyesters may contain up to about 25 mol % of other monomers such as ethylene glycol (EG or MEG), and/or other aliphatic dicarboxylic acid groups having from about 4 to about 12 carbon atoms as well as aromatic or cycloaliphatic dicarboxylic acid groups having from about 8 to about 14 carbon atoms. Non-limiting examples of these monomers include isophthalic acid (IPA), phthalic acid, succinic acid, adipic acid, sebacic acid, azelaic acid, cyclohexane diacetic acid, naphthalene-2,6-dicarboxylic acid, 4,4-diphenylene-dicarboxylic acid, and mixtures thereof.

The polymer also may contain up to about 25 mol % of other aliphatic C₂-C₁₀ or cycloaliphatic C₆-C₂₁ diol components. Non-limiting examples include neopentyl glycol, pentane-1,5-diol, cyclohexane-1,6-diol, cyclohexane-1,4-dimethanol, 3-methyl pentane-2,4-diol, 2-methyl pentane-2,4-diol, propane-1,3-diol, 2-ethyl propane-1,2-diol, 2,2,4-trimethyl pentane-1,3-diol, 2,2,4-trimethyl pentane-1,6-diol, 2,2-dimethyl propane-1,3-diol, 2-ethyl hexane-1,3-diol, hexane-2,5-diol, 1,4-di(β-hydroxyethoxy)benzene, 2,2-bis-(4-hydroxypropoxyphenyl)propane, and mixtures thereof.

Polyesters may be synthesized according to well-known polytransesterification or direct polycondensation techniques. Catalysts conventionally used in polycondensation reactions include oxides or salts of silicon, aluminum, zirconium, titanium, cobalt, and combinations thereof. In some examples, antimony trioxide (Sb₂O₃) is used as a polycondensation catalyst.

Other conditions suitable for polycondensation reactions will be apparent to those skilled in the art, particularly in light of the examples described below.

### EXAMPLES

The following examples are provided to illustrate certain aspects of the invention and should not be regarded as limiting the spirit or scope of the present invention.

Materials

2,5-furandicarboxylic acid (FDCA) of 97% purity is commercially available from Aldrich. Isosorbide (IS) (1,4:3,6-dianhydro-D-glucitol) of purity 99% is commercially available from ADM Chemicals, USA. Bis-(hydroxymethyl)furan (BHMF) is commercially available from Polysciences, Inc., Germany. Ethylene glycol (≧99.5%), 1,4-butanediol (99%), adipic acid (≧99.5%), vanillic acid (VA) (≧97%), antimony oxide (99.999%), and other solvents described herein are commercially available from Aldrich.

Techniques

FTIR-ATR spectra were taken with a Perkin Elmer spectrometer (Paragon 1000) scanning infrared radiations with an acquisition interval of 125 nm. The ¹H NMR spectra were recorded on a Bruker AC 300 spectrometer operating at 300.13 MHz for ¹H spectra in CF₃COOD, DMSO D₆, CD₃COCD₃ using 30° pulses, 2000/3000 Hz spectral width, 2.048 s acquisition time, 50 s relaxation delay and 16 scans were accumulated. Differential scanning calorimetry (DSC) experiments were carried out with a DSC Q100 differential calorimeter (TA Instruments) fitted with a manual liquid nitrogen cooling system. The samples were placed in hermetically closed DSC capsules. The heating and cooling rates were 10° C. min⁻¹ and 5° C. min⁻¹ in N₂ atmosphere. Sample weights were between 5 and 15 mg. Structures were confirmed using conventional Size Exclusion Chromatography Multi-Angle Laser Light Scatter (SEC-MALLS), Thermogravimetric Analysis (TGA), and x-ray diffraction (XRD) techniques.

### Example 1

This example describes a process for the synthesis of the monomer 2,5-dimethyl furan dicarboxylate (FDE) by esterification.

In a round bottom flask of 500 ml, 10 g of 2,5-furandicarboxylic acid, 5 ml of HCl and 120 ml of methanol (excess) were added. The mixture was heated to 80° C. for 9 hrs. under reflux and magnetic stirring. The reaction mixture was cooled at room temperature (for total precipitation, the mixture was cooled in a refrigerator or in a freezer for one day) and the off-white precipitate formed was isolated by filtering the solution and washed (separately the precipitate in beaker repeatedly with methanol and filtered the solution) before drying. The reaction yield was 97%.

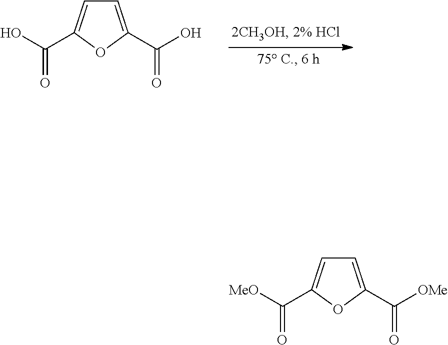 [SMILES: O=C(O)c1ccc(C(=O)O)o1 ; COC(=O)c1ccc(C(=O)OC)o1]

This 2,5-dimethyl furanic ester is soluble in methanol, ethanol, acetone, DMSO and diisopropyl ether.

### Example 2A

This example describes preparing poly(ethylene 2,5-furandicarboxylate) (PEF) by polytransesterification.

In a round bottom flask of 50 ml, 3.68 g (0.02 mol) of 2,5-dimethyl furan dicarboxylate and 1.11 ml (0.02 mol) of ethylene glycol and 0.01 g (0.000034 mol) of Sb₂O₃ were added. This mixture was well stirred under a stream of nitrogen for 1 hr. Then, the nitrogen flow was discontinued and the mixture was heated for 3 hrs. at 220° C. (until it becomes viscous). When the solution became viscous, the released methanol was removed by pumping the reactor under vacuum. The released methanol was collected in a trap cooled with liquid N₂ for 5-10 minutes. Then, the temperature was reduced to 150° C. and the viscous polymer was dissolved in DMSO (15 ml) under heating. After dissolution in DMSO, the polymer was precipitated in methanol, filtered and washed with methanol before being dried. The each trial yields were 66, 38 and 30%, respectively.

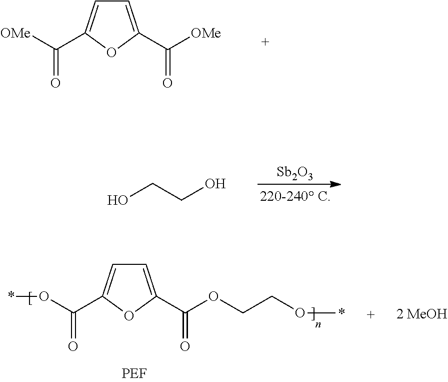

### Example 2B

This example describes preparing poly(ethylene 2,5-furandicarboxylate) (PEF) by direct polycondensation.

A molar ratio of 1:1.5 of acid to glycols and 0.02 g of Sb₂O₃ were used. As a direct polycondensation reaction, water molecules are released instead of methanol, and the yield amount is high.

In a round bottom flask of 100 ml, 3.12 g (0.02 mol) of 2,5-furan dicarboxylic acid, 1.64 ml (0.03 mol) of ethylene glycol and 0.02 g (0.000068 mol) of Sb₂O₃ were added. This mixture was well stirred under a stream of nitrogen for 1 hr. Then the nitrogen flow was stopped and the mixture was heated for slowly increasing the temperature up to 220° C. for 7 hrs. Then the temperature was increased slowly to 240-250° C. and the mixture maintained under heating for 5 hrs. When the solution becomes viscous, the released water was removed by pumping the reactor under vacuum. The released water was collected in a trap cooled with liquid N₂ for 2-3 minutes. Then, the temperature was reduced to 150° C. and the viscous polymer was dissolved in DMSO (15 ml) under heating at 180° C. for 4-5 hrs. After dissolution in DMSO, the polymer was precipitated in methanol, filtered, washed with methanol and dried. The yields were 52 and 97%.

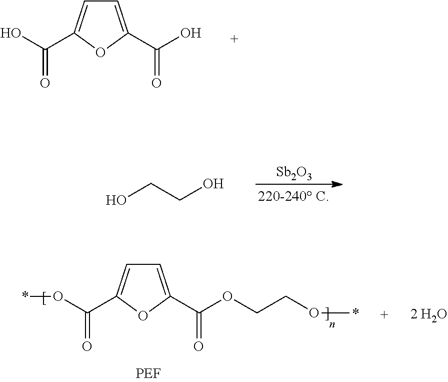

### Example 3A

This example illustrates preparing poly(butylene 2,5-furandicarboxylate) (PBF) by polytransesterification.

In a round bottom flask of 50 ml, 3.68 g (0.02 mol) of 2,5-dimethyl furandicarboxylate and 1.76 ml (0.02 mol) of 1,4-butanediol and 0.01 g (0.000034 mol) of Sb₂O₃ were added. This mixture was stirred well in a nitrogen atmosphere for 1 hr. Then the nitrogen flow was stopped and the mixture was heated for 7 hrs. 220° C. (until it becomes viscous). When the solution became viscous, the methanol released was collected in a trap under vacuum and cooled with liquid N₂ for 5-10 minutes. Then the temperature was reduced to 150° C. and the viscous polymer dissolved in DMSO (15 ml) under heating. After dissolving in DMSO, it was precipitated in methanol, filtered and washed with methanol, before being dried. The yields were 12 and 9%.

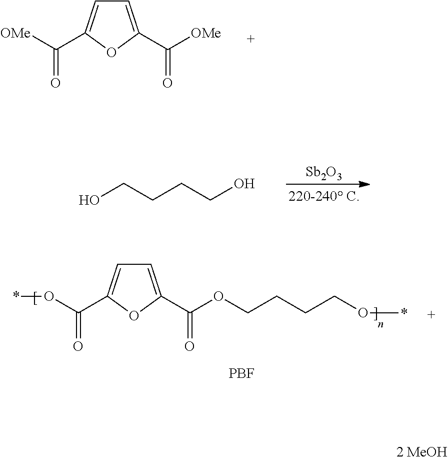

### Example 3B

This example describes preparing poly(butylene 2,5-furandicarboxylate) (PBF) by direct polycondensation.

In a round bottom flask of 100 ml, 3.12 g (0.02 mol) of 2,5-furan dicarboxylic acid, 2.65 ml (0.03 mol) of 1,4-butanediol and 0.02 g (0.000068 mol) of Sb₂O₃ were added. This mixture was well stirred under a stream of nitrogen for 1 hr. Then, the nitrogen flow was stopped and the mixture was heated for slowly increasing the temperature up to 220-230° C. The reaction mixture was then maintained at this temperature for 10 hrs. Then, the temperature is increased slowly to 250-260° C. and the mixture maintained under heating for another 10 hrs. When the solution became viscous, the released water was removed by pumping the reactor under vacuum. The released water was collected in a trap cooled with liquid N₂ for 4-5 minutes. Then, the temperature was reduced to 180° C. and the viscous polymer was dissolved in DMSO (25 ml) under heating at 180° C. for 3-4 hrs. After dissolution in DMSO, the polymer was precipitated in methanol, filtered, washed with methanol and dried. The yields were 32 and 40%.

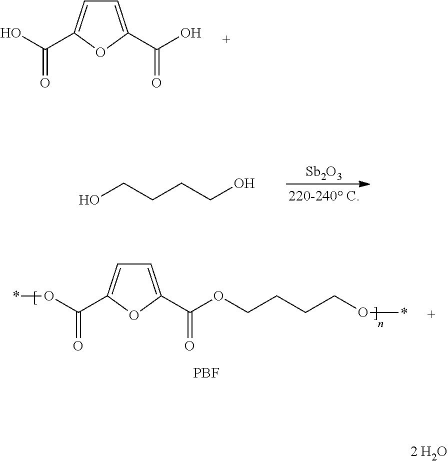

### Example 4

This example illustrates preparing a polyester from isosorbide (PIF).

In a round bottom flask of 100 ml, 3.12 g (0.02 mol) of 2,5-furan dicarboxylic acid, 4.38 g (0.03 mol) of 1,4:3,6-dianhydro-D-glucitol and 0.02 g (0.000068 mol) of Sb₂O₃ were added. This mixture was stirred under a stream of nitrogen for 1 hr. Then the nitrogen flow was stopped and the mixture was heated for slowly increasing the temperature up to 220-230° C. When reaching this temperature value, the mixture was kept to react for 10 hrs. Then, the temperature was again increased slowly to 250-260° C. and the mixture again maintained under heating for another 10 hrs. When the solution became viscous, the released water was removed by pumping the reactor under vacuum. The released water was collected in a trap cooled with liquid N₂ for 4-5 minutes. Then the temperature was reduced to 180° C. and the viscous polymer was dissolved in DMSO (20 ml) under heating at 180° C. for 3-4 hrs. After dissolution in DMSO, the polymer was precipitated in methanol, filtered, washed with methanol and dried. The reaction yield was around 57%.

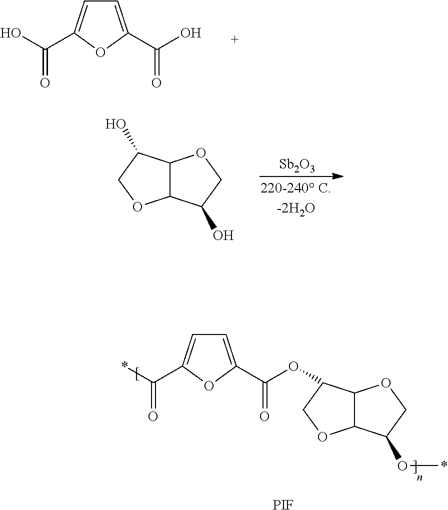

### Example 5

This example illustrates preparing poly(2,5-furandimethylene adipate) (PFA).

In a round bottom flask of 100 ml, 2.923 g (0.02 mol) of adipic acid, 3.843 g (0.03 mol) of BHMF and 0.02 g (0.000068 mol) of Sb₂O₃ were added. This mixture was well stirred under a stream of nitrogen for 1 hr. Then, the nitrogen flow was stopped and the mixture was heated for slowly increasing the temperature up to 190-220° C. The reaction mixture was then maintained at this temperature for 10 hrs. Then the temperature was increased slowly to 230-240° C. and the mixture maintained under heating for another 10 hrs. When the solution became viscous, the released water was removed by pumping the reactor under vacuum. The released water was collected in a trap cooled with liquid N₂ for 4-5 minutes. The temperature was then reduced to ambient temperature and the polymer was recovered without using any solvent (neither DMSO nor methanol). The reaction yield was 62%.

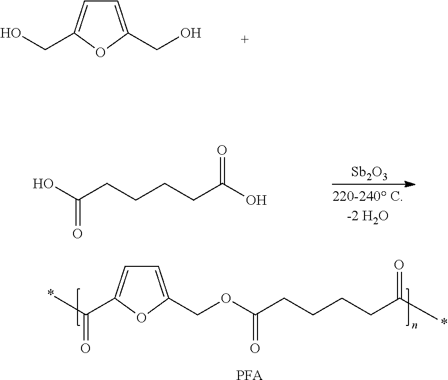

### Example 6

This example illustrates preparing polyvanillic ester (PVE).

In a round bottom flask of 100 ml, 5.0445 g (0.03 mol) of vanillic acid, 0.02 g (0.000068 mol) of Sb₂O₃ were added. This mixture was well stirred under a stream of nitrogen for 1 hr. The nitrogen flow was then stopped and the mixture was heated for slowly increasing the temperature up to 220-230° C. At this plateau, the mixture was left to react for 7 hrs. Then the temperature was increased slowly to 250-260° C. and the mixture maintained under heating for another 6½ hrs. When the solution became viscous, the released water was removed by pumping the reactor under vacuum. The released water was collected in a trap cooled with liquid N₂ for 4-5 minutes. Then the temperature was reduced to 180° C. and the viscous polymer was dissolved in DMSO (20 ml) under heating at 180° C. for 3-4 hrs. After dissolution in DMSO, half of the polymer solution was precipitated in methanol, filtered, washed with methanol and dried. The other half was recovered and characterised as such. The reaction yield was around 60%.

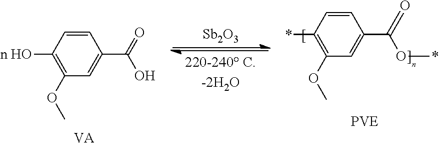

### Example 7

This example illustrates preparing polyethylene isosorbide furandicarboxylate (PEIF).

In a round bottom flask of 100 ml, 3.12 g (0.02 mol) of 2,5-furandicarboxylic acid, (n mol) of ethylene glycol and 0.2192 g (m mol) of isosorbide and 0.02 g (0.000068 mol) of Sb₂O₃ were added. This mixture was well stirred under a stream of nitrogen for 1 hr. Then, the nitrogen flow was stopped and the mixture was heated for slowly increasing the temperature up to 200-230° C. The reaction mixture was then maintained at this temperature for 11 hrs. Thereafter, the temperature was increased slowly to 245-255° C. and the mixture maintained under heating for another 14 hrs. Vacuum was applied to remove the water released in the reaction medium by pumping the reactor under vacuum. The released water was collected in a trap cooled with liquid N₂ for 4-5 minutes. This was heated again for 5 hr. Then, the temperature was reduced to ambient temperature and the polymer was collected.

Copolyesters with four different mole ratios of ethylene glycol and isosorbide were synthesized. Yields obtained were from 70-90%.

### Example 8

This example illustrates preparing the copolyester PBTF.

In a round bottom flask of 100 ml, 1.56 g (0.01 mol) of 2,5-furandicarboxylic acid, (0.03 mol) of ethylene glycol and 1.66 g (0.01 mol) of terephthalic acid and 0.02 g (0.000068 mol) of Sb₂O₃ were added. This mixture was well stirred under a stream of nitrogen for 1 hr. Then, the nitrogen flow was stopped and the mixture was heated for slowly increasing the temperature up to 200-230° C. The reaction mixture was then maintained at this temperature for 12 hrs. Then, the temperature was increased slowly to 245-255° C. and the mixture maintained under heating for another 18 hrs. Vacuum was applied to remove the water released in the reaction medium by pumping the reactor under vacuum. The released water was collected in a trap cooled with liquid N₂ for 4-5 minutes. This was heated again for 1 hr. Then, the temperature was reduced to ambient temperature and the polymer was collected. The reaction yield was around 40%.

Results and Discussion

All the monomers including the purchased one were studied using DSC, NMR, FTIR, SEC-MALLS, XRD, and TGA.

Monomers

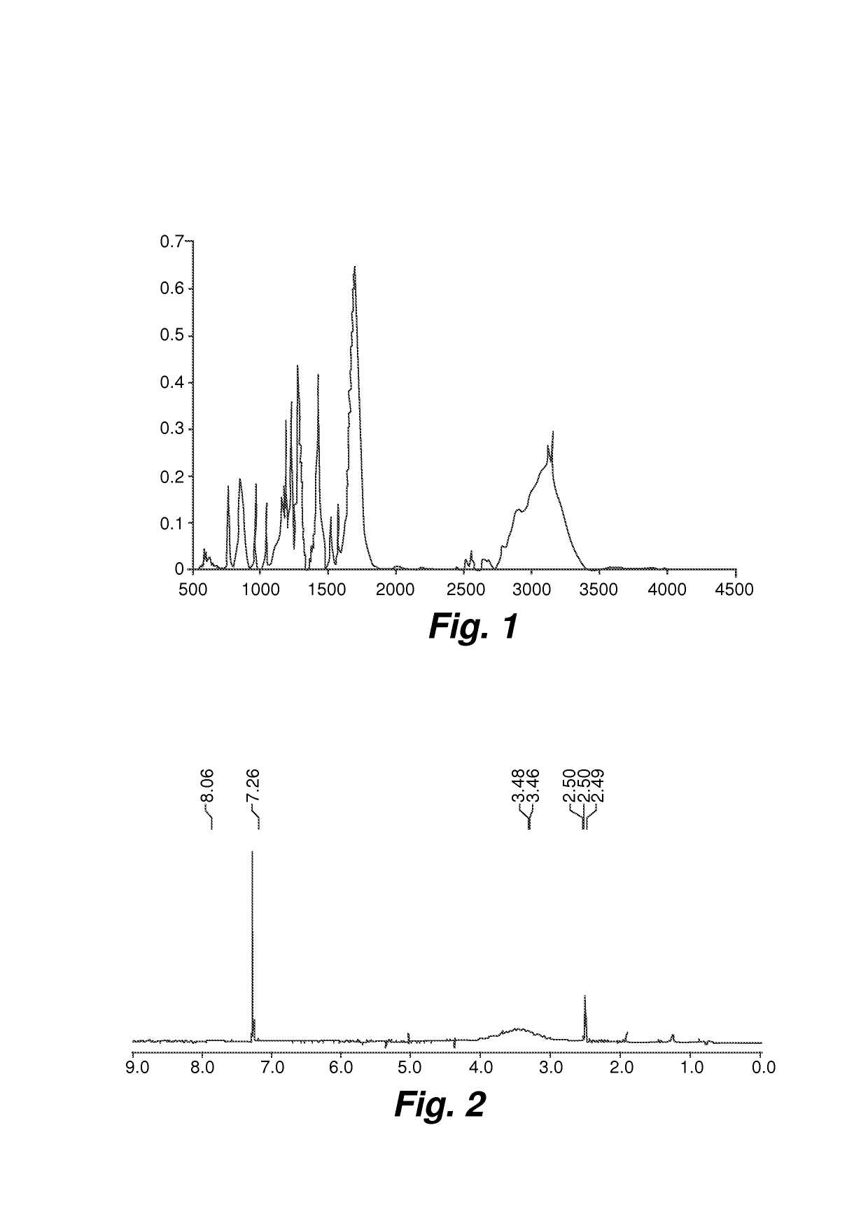

FIG. 1 shows the FTIR for 2,5-furandicarboxylic acid (FDCA). The main peaks and their assignments are:

| | | |
|---|---|---|
| (Carboxylic acid) C═O | 1678 | cm⁻¹ |
| Elongation of O—H (acid) | 2700-3400 | cm⁻¹ |
| Furan ring (C═C) | 1570 | cm−¹ |
| Acid (C—O—H bending) | 1400 | cm⁻¹ |
| Furan ring (Bending of C—H and furan ring) | 960,840,762 | cm⁻¹ |

FIG. 2 shows the NMR for FDCA in the solvent DMSO. In the ¹H-NMR, the signal at the chemical shift (δ) of 7.26 ppm corresponds to the protons H3 and H4 of the furan ring, whereas that appearing at 3.46 ppm is assigned to the OH of the acid and that observed at 2.50 ppm is due to DMSO.

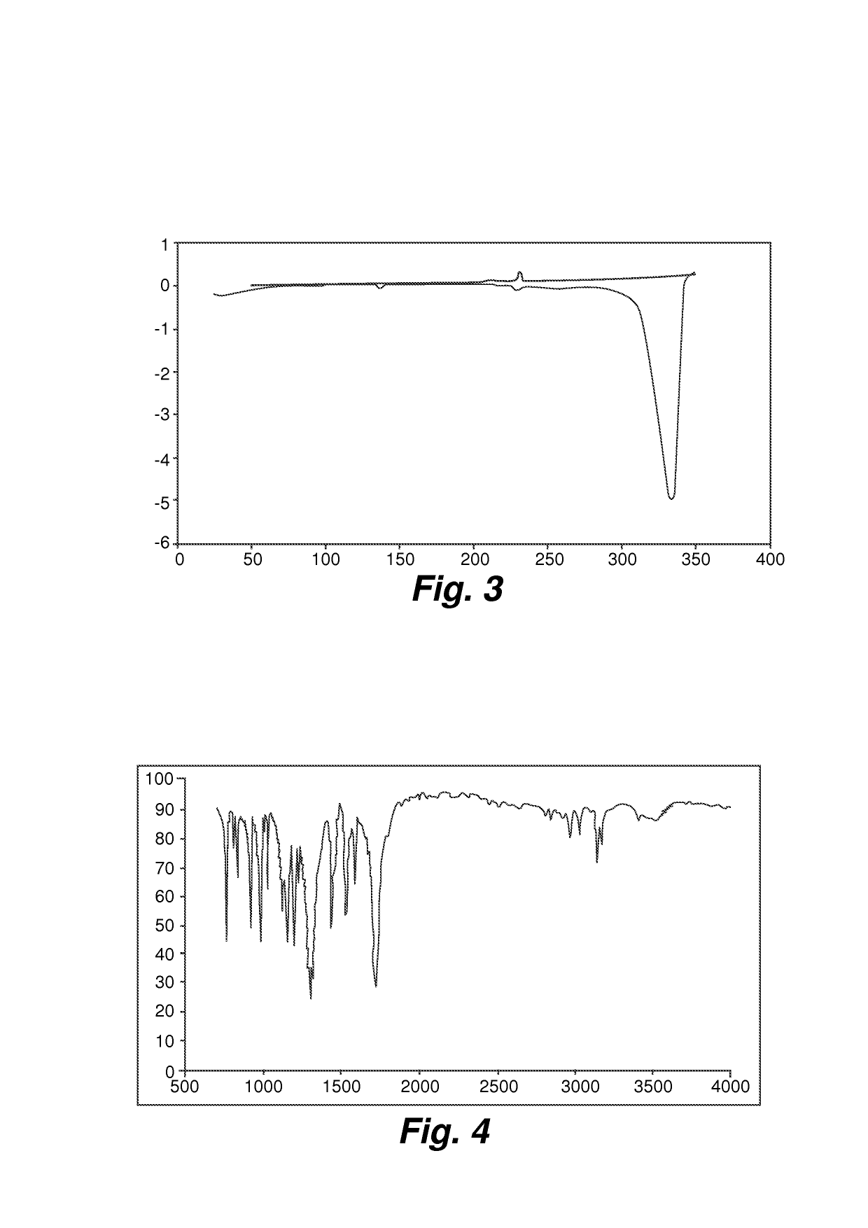

FIG. 3 shows the DSC for FDCA. The DSC protocol is as follows:

(1) Ramp 50° C. to 350° C. at 10° C./min

(2) Isothermal for 5 min

(3) Ramp 350° C. to 50° C. at 10° C./min.

From the DSC tracings, the melting temperature at T_{f}=334° C. and the crystallization exotherm at T_{c}=232° C. are observed.

2,5-dimethyl furandicarboxylate (FDE)

FIG. 4 shows the FTIR for FDE. The main peaks and their assignments are:

| | |
|---|---|
| C═H (furan ring) | 3142 cm⁻¹ |
| C—H (methyl) | 2965 cm⁻¹ |
| C═O | 1712 cm⁻¹ |
| C—O (ester) | 1298 cm⁻¹ |

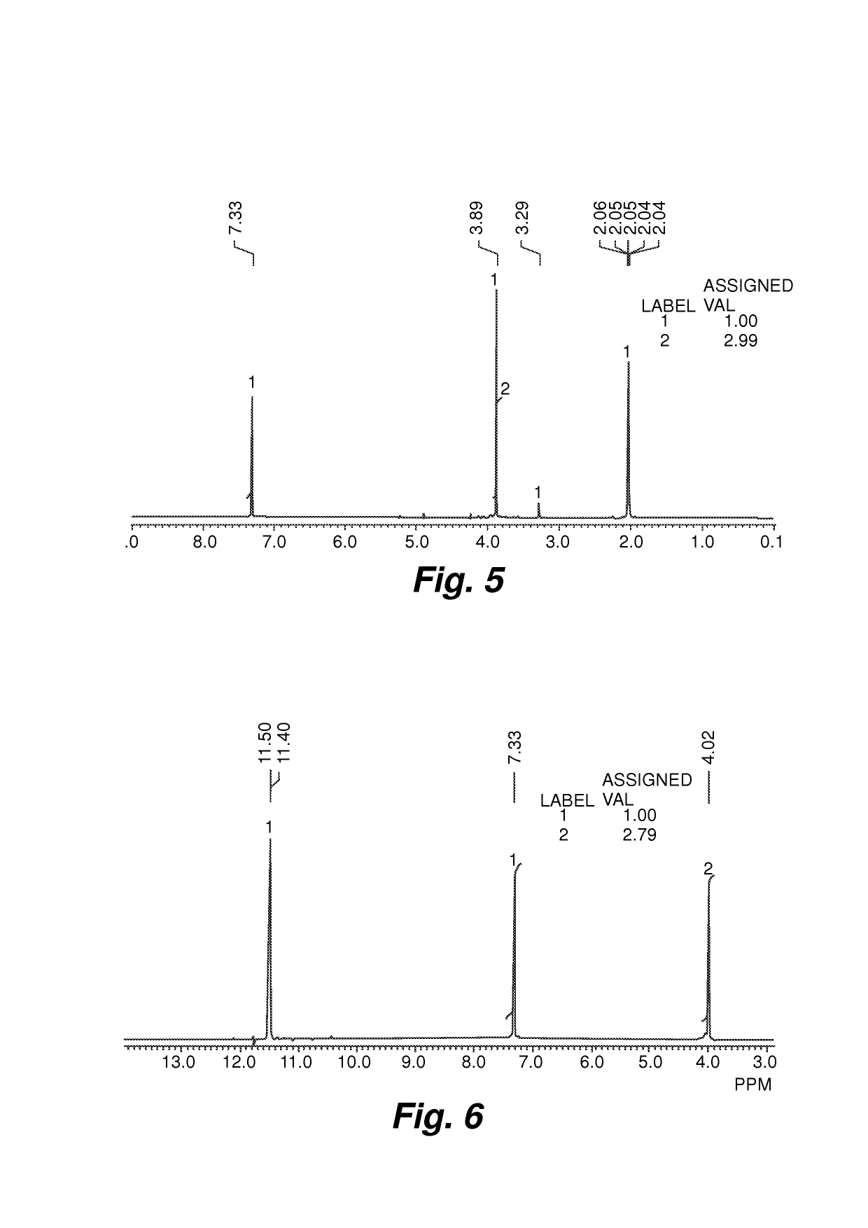

FIG. 5 shows the NMR for FDE in the solvent CD₃COCD₃. In the spectrum, the signal at δ 7.33 ppm corresponds to the H3 and H4 protons of furanic ring whereas that appearing at δ 3.86 ppm could be assigned to the CH₃ of the formed ester group.

FIG. 6 shows the NMR for FDE in another solvent, CF₃COOD. When using the solvent (CF₃COOD), we obtain similar spectrum with peaks at δ=7.33 ppm and δ=4.02 ppm which correspond to one proton of furan ring and the CH₃ of the ester, respectively. The δ=11.5 ppm corresponds to the solvent.

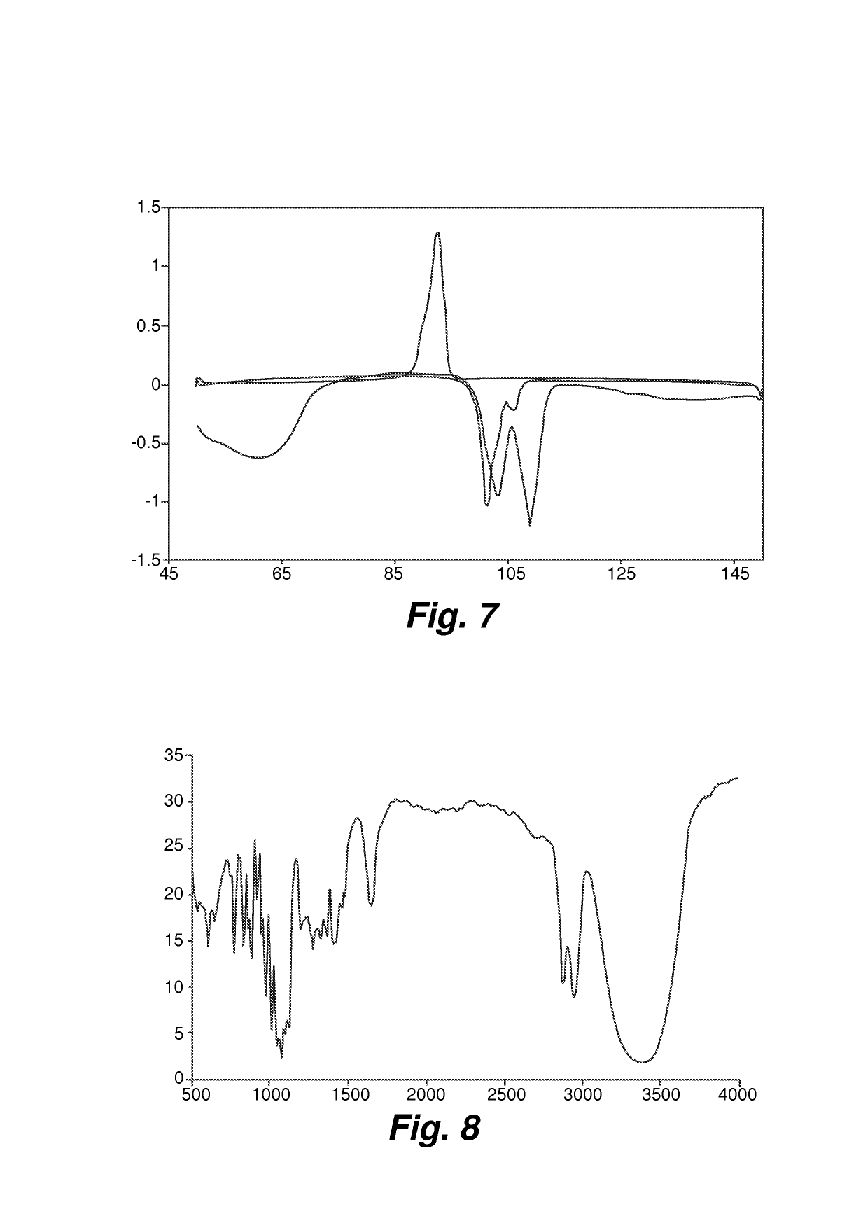

FIG. 7 shows the DSC for FDE. The DSC protocol used is given below.

(1) Heating step from 50° to 150° C. at 5° C./min

(2) Isothermal for 5 min

(3) Cooling step from 150° to 50° at 5° C./min

(4) Isothermal for 5 min

(5) Second heating step 50° to 150° C. at 5° C./min.

First heating was to remove the thermal history of the monomer. From the DSC thermogram, it could be observed that the Tₘ of the dimethyl ester monomer of FDCA is at about ˜110° C. The high T_{f} value (334° C.) of FDCA may be due to strong cohesive energy due to intermolecular hydrogen bonds. But in the case of diester there are no such interactions (110° C.), because the hydrogen bonds arising from carboxylic functions were broken when the COOH groups were converted to COOMe counterpart.

Isosorbide (IS)

FIG. 8 shows the FTIR for isosorbide (IS) (KBr). The IR spectra displayed the presence of the peaks at 3374 (OH elongation), 2943, 2873 cm⁻¹, corresponding to methyl elongation (asymmetric and symmetric) and those at 1120, 1091, 1076, 1046 cm⁻¹, attributed to the vibration of C—O—C.

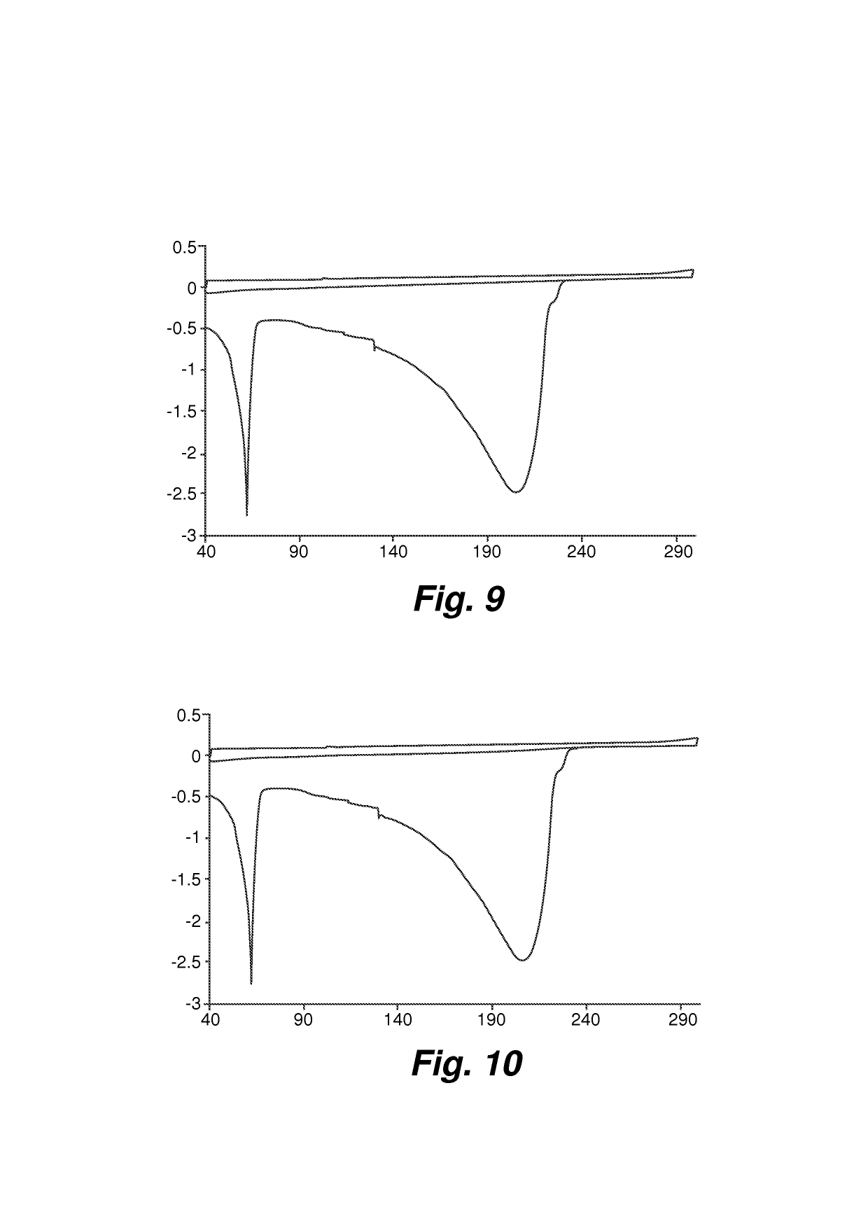

FIGS. 9 and 10 show the DSC for IS. The DSC protocol used is given below.

(1) Heating step from 50° to 300° C. at 10° C./min

(2) Isothermal for 5 min

(3) Cooling step 300° to 50° at 10° C./min

(4) Isothermal for 5 min

(5) Second heating step 50° to 300° C. at 10° C./min (FIG. 9)

(6) 1^{st} Ramp (50° C.-300° C. at 10° C./min) (FIG. 10).

It is observed that isosorbide gives a melting point at 62° C. and that its thermal degradation starts around ˜205° C.

2,5-Bis(hydroxymethyl)Furan (BHMF)

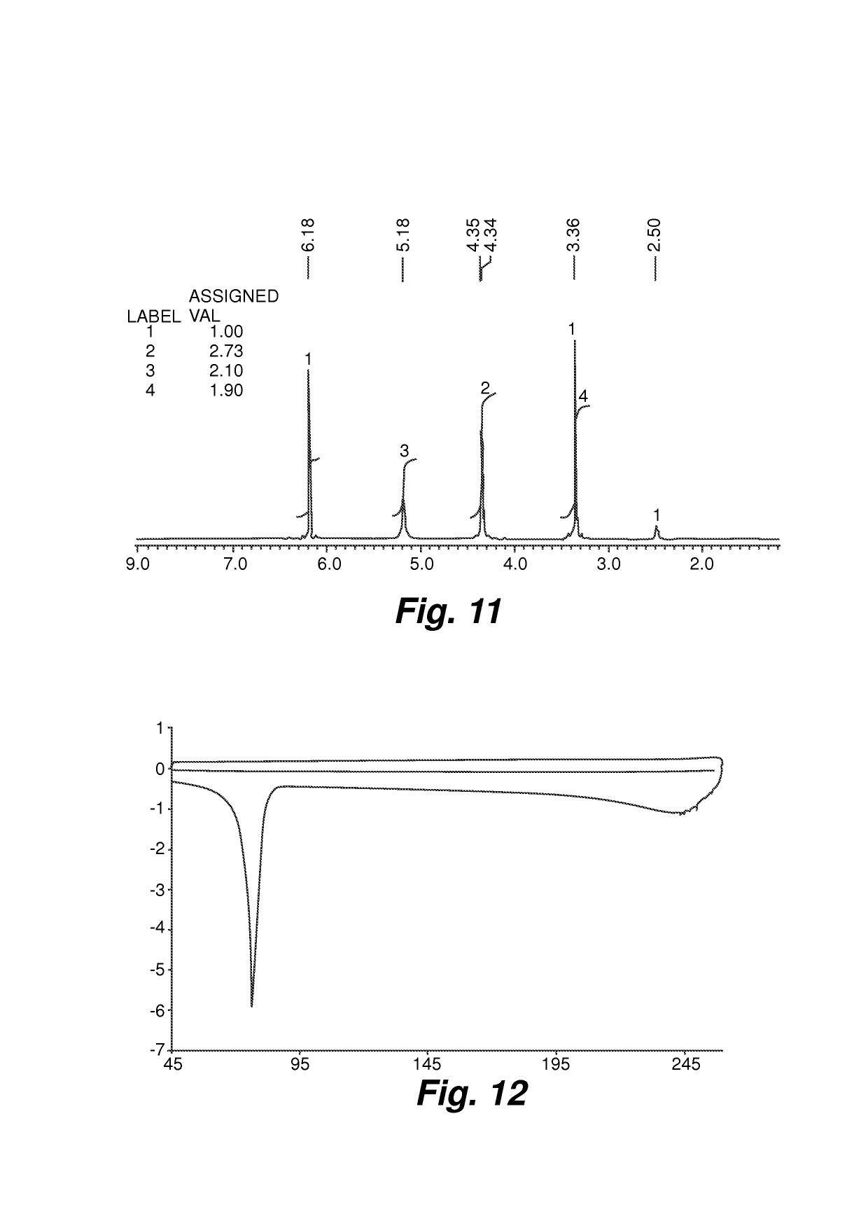

FIG. 11 shows the NMR for BHMF in the solvent DMSO. The NMR spectrum shows several shifts, namely: at δ=6.18 ppm which corresponds to 2H of furan ring, δ=5.18 ppm assigned to the OH, δ=4.35 ppm attributed to the 4H of the CH₂OH, δ=3.36 and 2.25 ppm associated with the solvent and OH of the water present in it.

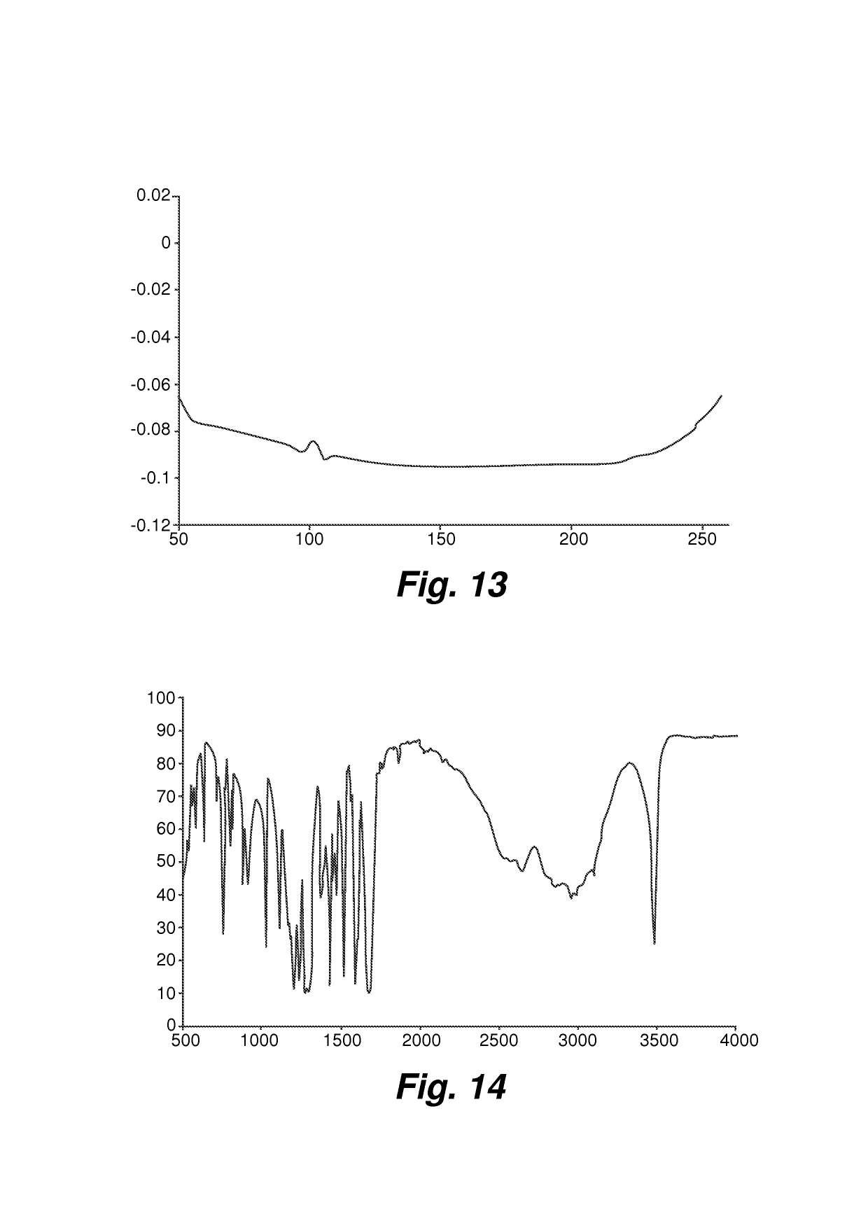

FIGS. 12 and 13 show the DSC for BHMF. FIG. 12 shows the full thermodiagram of BHMF; and FIG. 13 shows the second heating step. The protocol is as follows.

(1) Heating step 10° C./min to 260° C.

(2) Isothermal for 5 min

(3) Cooling step 10° C./min to 45° C.

(4) Isothermal for 5 min

(5) Second heating step 10° C./min to 260° C.

(6) Ramp 10° C./min to 260° C. (3^{rd} step).

From the DSC thermogram, a melting point Tₘ of ˜77° C. is observed for BHMF. The degradation of the monomer starts at a temperature of around 230° C. In the 2^{nd} and 3^{rd} steps, i.e., the cooling and heating steps, there is a small peak observed at ˜100° C. This can be due to the crystallization (cooling step) and evaporation (heating step) of water. No other peaks (Tₘ, T_{c}) were detected.

Vanillic Acid (VA)

FIG. 14 shows the FTIR for VA. From the FTIR spectrum, one could draw the following assignments: the peak at 3483 cm⁻¹ corresponds to the OH elongation (phenolic); 2963 cm⁻¹ is attributed to in phase OH (COOH) stretching and CH asymmetrical stretching; and 2628 cm⁻¹ is assigned to CH symmetrical stretching. The band at 1673 cm⁻¹ corresponds to C═O stretching and that appearing at 585 cm⁻¹ corresponds to OH (phenol) in plane deformation.

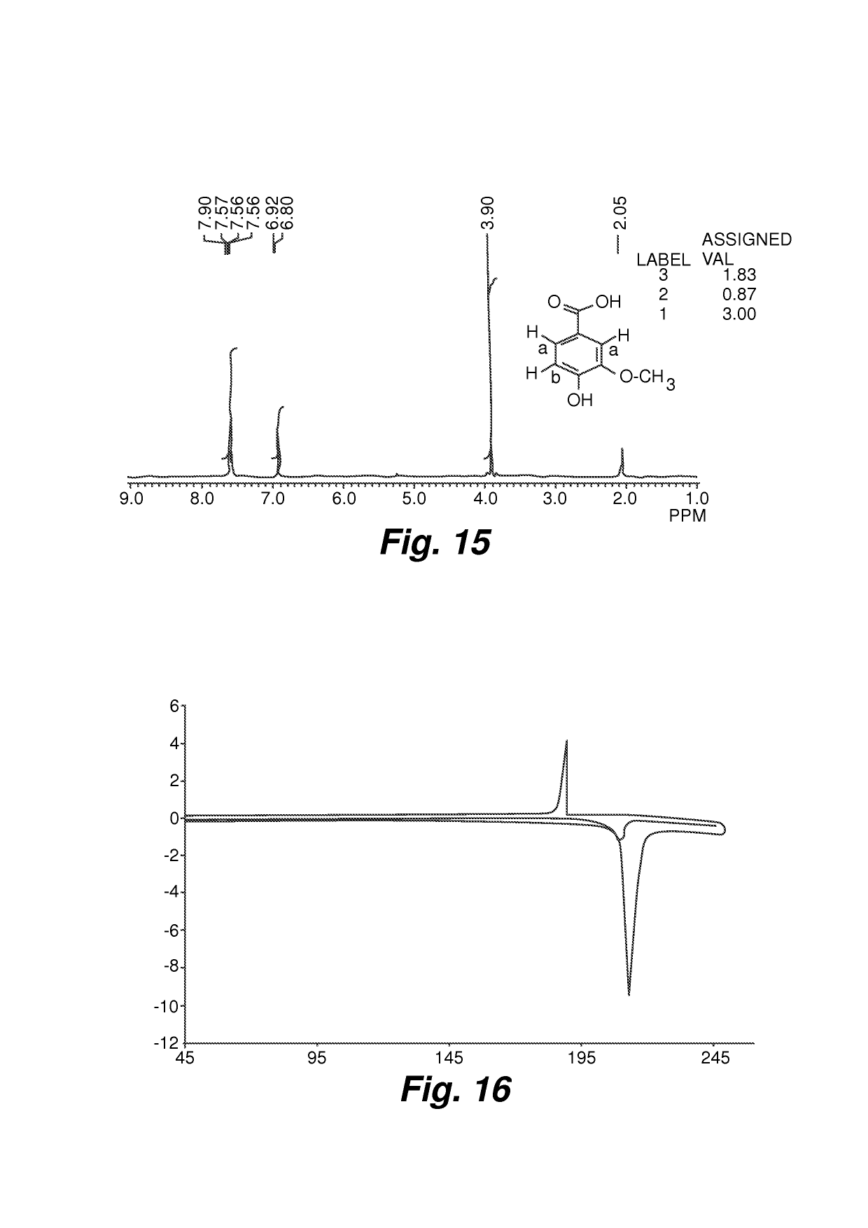

FIG. 15 shows the NMR for VA in the solvent CD₃COCD₃. The NMR spectrum gives chemical shifts at δ=7.6 ppm, which corresponds to the 2Hₐ, δ=6.9 ppm to the 1H_{b}, δ=3.9 ppm to the 3H of CH₃ and δ=2.05 ppm of the solvent.

FIG. 16 shows the DSC for VA. The DSC protocol is:

(1) Ramp 50° C. to 250° C. at 10° C./min

(2) Isothermal for 5 min

(3) Ramp 250° C.-50° C. at 10° C./min

(4) Isothermal for 5 min

(5) Ramp 50° C.-250° C. at 10° C./min.

It is observed that the melting point of vanillic acid at 210° C. and the crystallization temperature at 190° C., which agrees with the literature data.

Polymers

From the experimental section it can be observed that the yield of the polymers obtained are high in direct polycondensation method compared to the polytransesterification method.

a) Polytransesterification

Poly(ethylene 2,5-furandicarboxylate) (PEF)

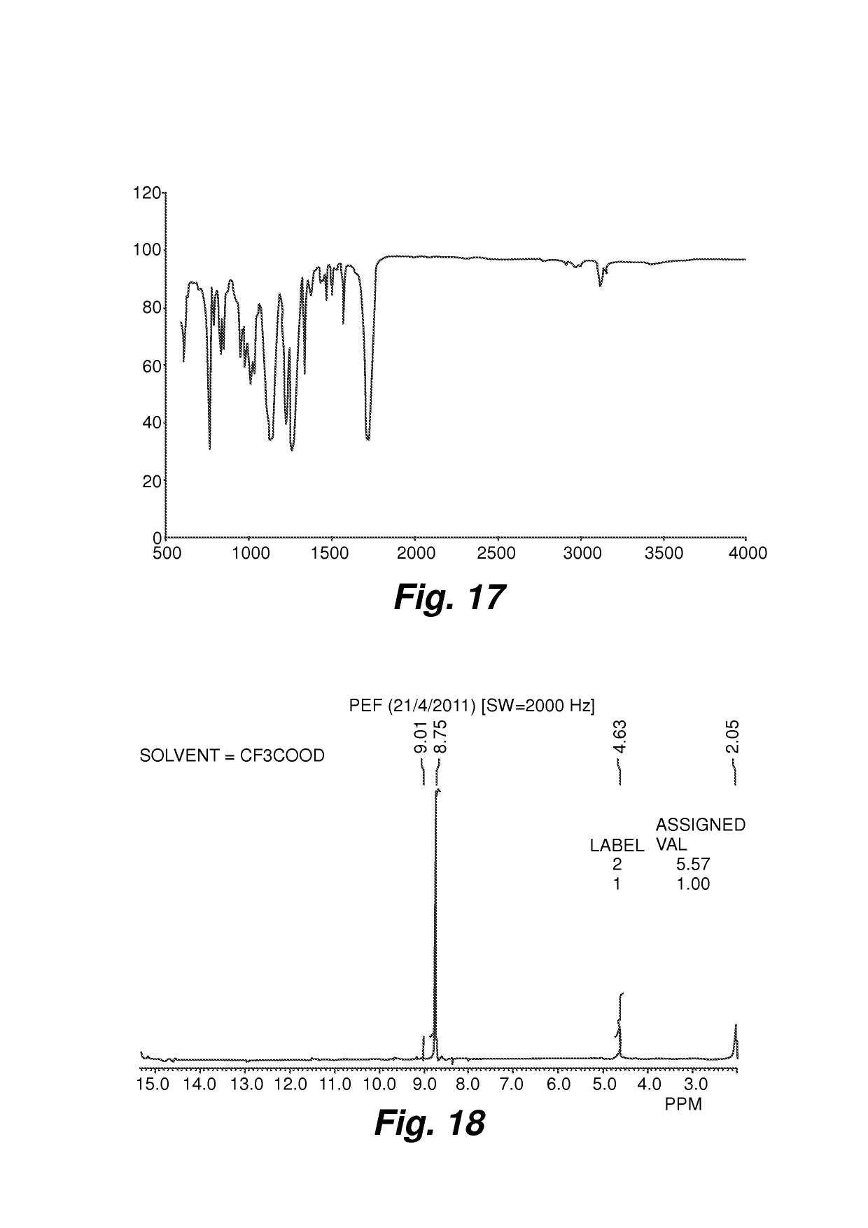

FIG. 17 shows the FTIR for PEF. The FTIR spectrum shows peaks (cm⁻¹) at 1715 and 1264 corresponding to the ester carbonyl and C—O moieties and the characteristic bands of disubstituted furanic rings (3120, 1575, 1013, 953, 836 and 764). It is observed that the band characteristic of OH (3400) disappeared. So it can be confirmed that no acid monomer is left.

FIG. 18 shows the NMR for PEF in the solvent CF₃COOD. In the solvent DMSO, the resonance peaks corresponding to furanic H3 and H4 at δ 7.4 ppm and that of ester CH₂ at δ 4.6 ppm are observed with an approximate ratio of integration 1:2. It seems that there is an excess of furanic protons. In the solvent CF₃COOD, it was found that the chemical shift (δ) value of H3 and H4 protons of furanic ring is shifted to ≈8.75 ppm instead of ≈7.33 ppm, and also the integration value was not in agreement with the expected structure.

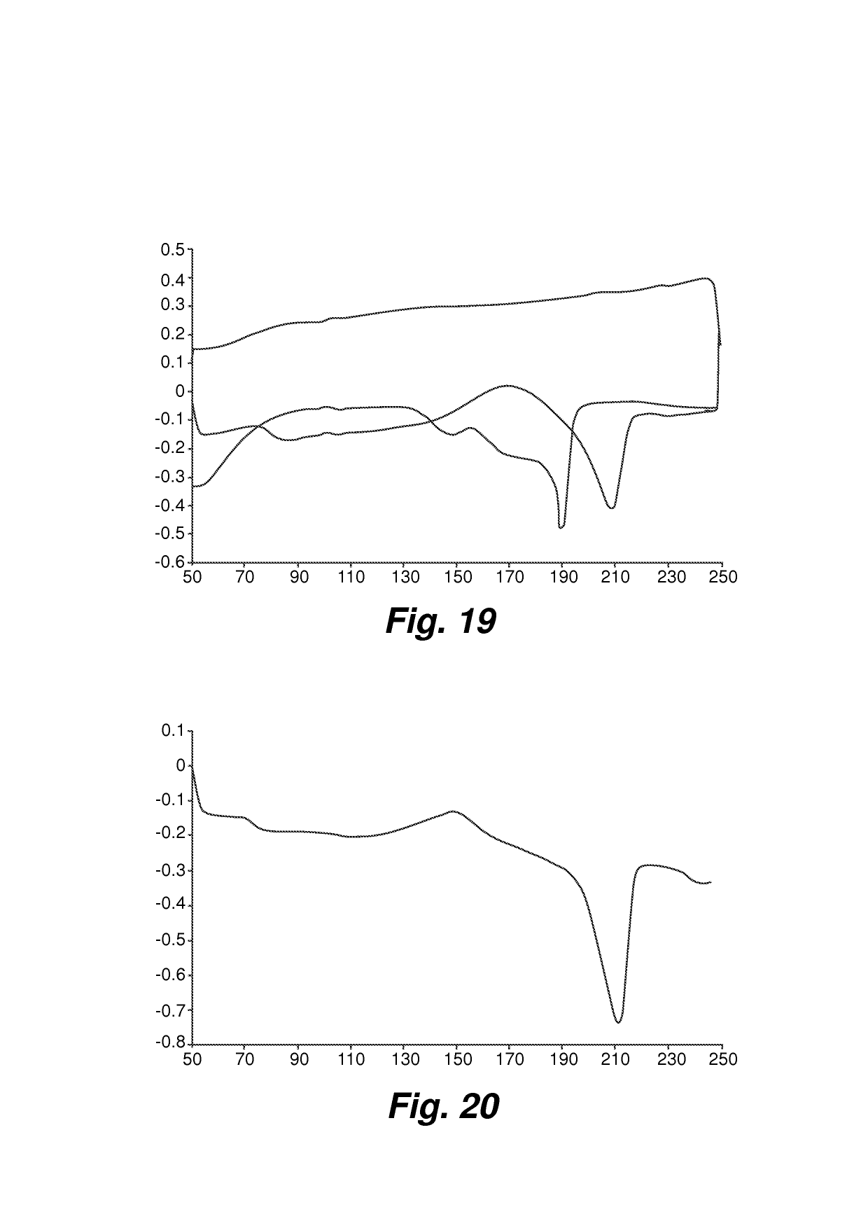

FIGS. 19 and 20 show the DSC for PEF. The DSC protocol used is given below.

(1) Ramp 50-250° C. at 10° C./min

(2) Isothermal for 5 min

(3) Ramp 250-50° C. at 10° C./min

(4) Isothermal for 5 min

(5) Ramp 50-250° C. at 10° C./min (FIG. 19)

(6) 3^{rd} Step (Ramp 50° C.-250° C. at 10° C./min) (FIG. 20).

First heating removes the thermal history of the polymer. From the second curve, they showed a high melting temperature at 212° C. and a Tg at around ˜74° C. (similar to PET) and also a crystallization exotherm at 150° C.

Poly(butylene 2,5-furandicarboxylate) (PBF)

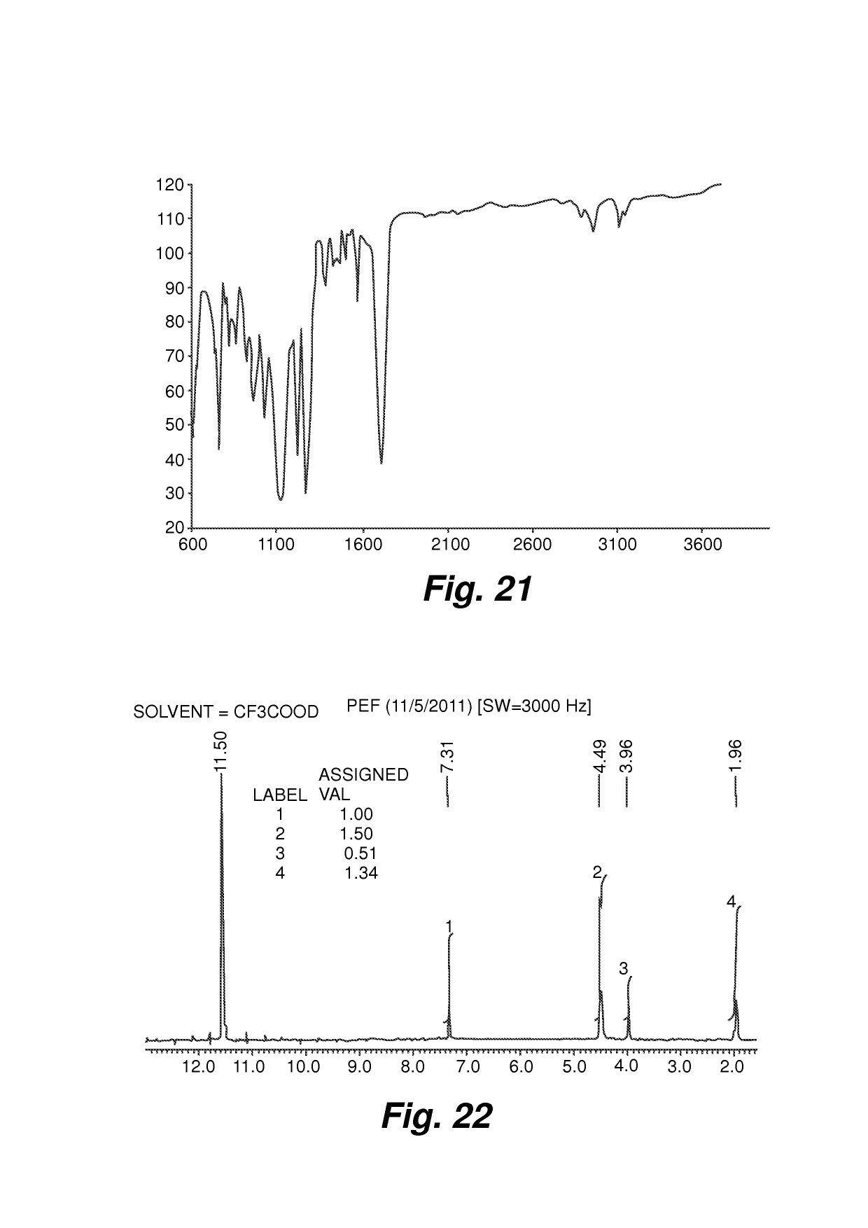

FIG. 21 shows the FTIR for PBF. The spectrum shows peaks at 3113, 1573, 1030, 964, 829, 767 cm⁻¹, corresponding to 2,5-disubstituted furanic rings. The C═O ester corresponding band and the C—O stretching bands are found at 1715 and 1272 cm⁻¹. This spectrum shows that there is no diacid left. In fact, the diacid is fully converted to the polymer. The 2959 cm⁻¹ peak is due to the asymmetric stretching of the methylene groups, while the symmetric stretching of the methylene groups causes the weaker 2889 cm⁻¹ peak. Also, the peak at 1129 cm⁻¹, which is the characteristic of the asymmetric vibration of COC ether, which according to the literature is attributed to the formation of an ether link between terminal OH groups and/or could be assigned to C—O—C of the furan ring.

FIG. 22 shows the NMR for PBF. From the NMR spectra of PBF (both two trials), the synthesis of PBF is confirmed from the corresponding peak δ=7.3 ppm for the H3 and H4 protons of the furanic ring and δ=4.5 ppm for the α CH₂ and δ=1.98 ppm for the β CH₂ protons. Here also, the integration of these protons is not quantitatively correlated with the structure.

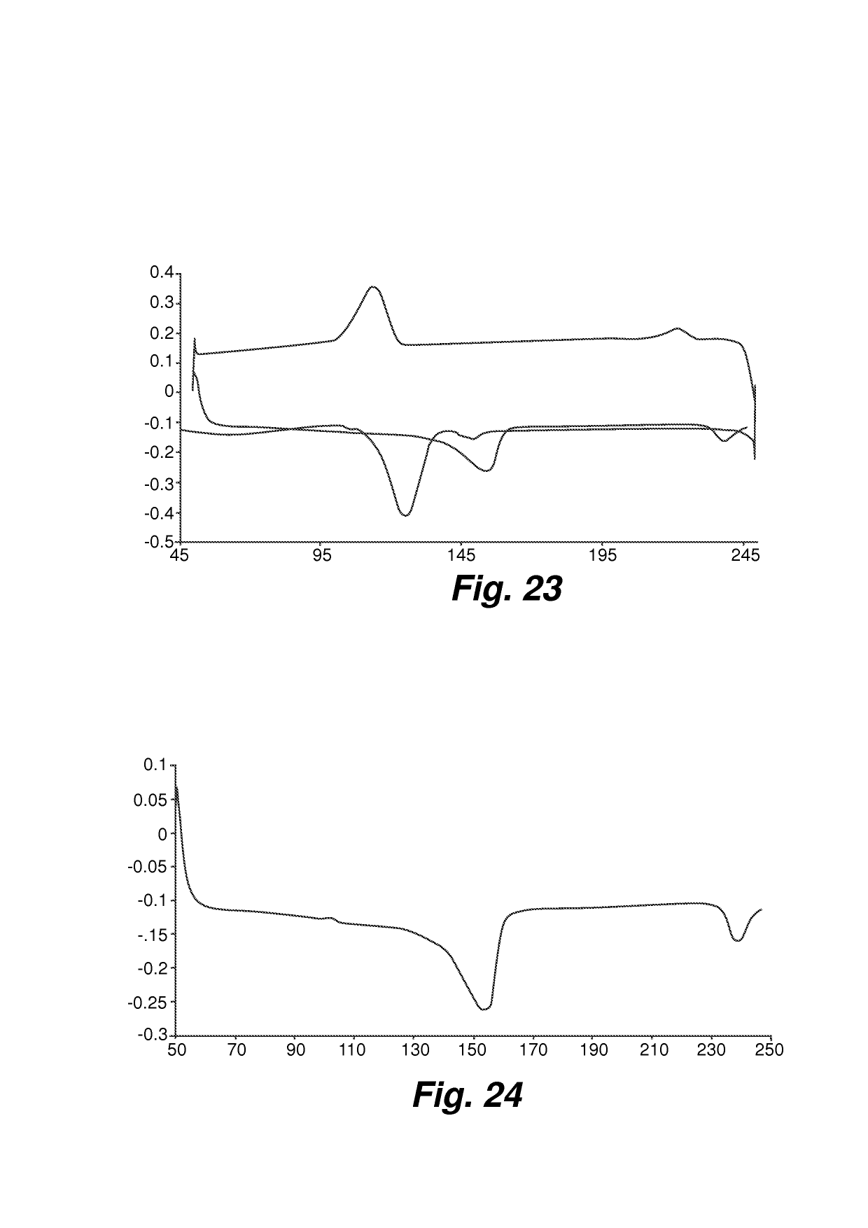

FIGS. 23 and 24 show the DSC for PBF. The DSC protocol used is given below.

(1) Ramp 50-250° C. at 10° C./min

(2) Isothermal for 5 min.

(3) Ramp 250-50° C. at 10° C./min

(4) Isothermal for 5 min.

(5) Ramp 50-250° C. at 10° C./min (FIG. 23)

(6) 3rd step (Ramp 50° C.-250° C. at 10° C./min) (FIG. 24).

From the above curves, they showed a melting temperature at 155° C. and 239° C., and a T_{g} at temperature ˜104° C. and also a crystallization exotherm at 112° C. and 221° C., respectively. This DSC tracing suggests that there are two different polymers. The large portion of the polymer has a Tₘ of around 155° C., whereas the remainder is composed of macromolecules with higher molecular weights having a Tₘ of 239° C. Such a result may indicate that the synthesis of PBF was not left to occur with the highest conversion possible and/or that the 1,4-butanediol has much lower reactivity to compare with ethylene glycol.

b) Direct Polycondensation

Poly(ethylene 2,5-furandicarboxylate) (PEF)

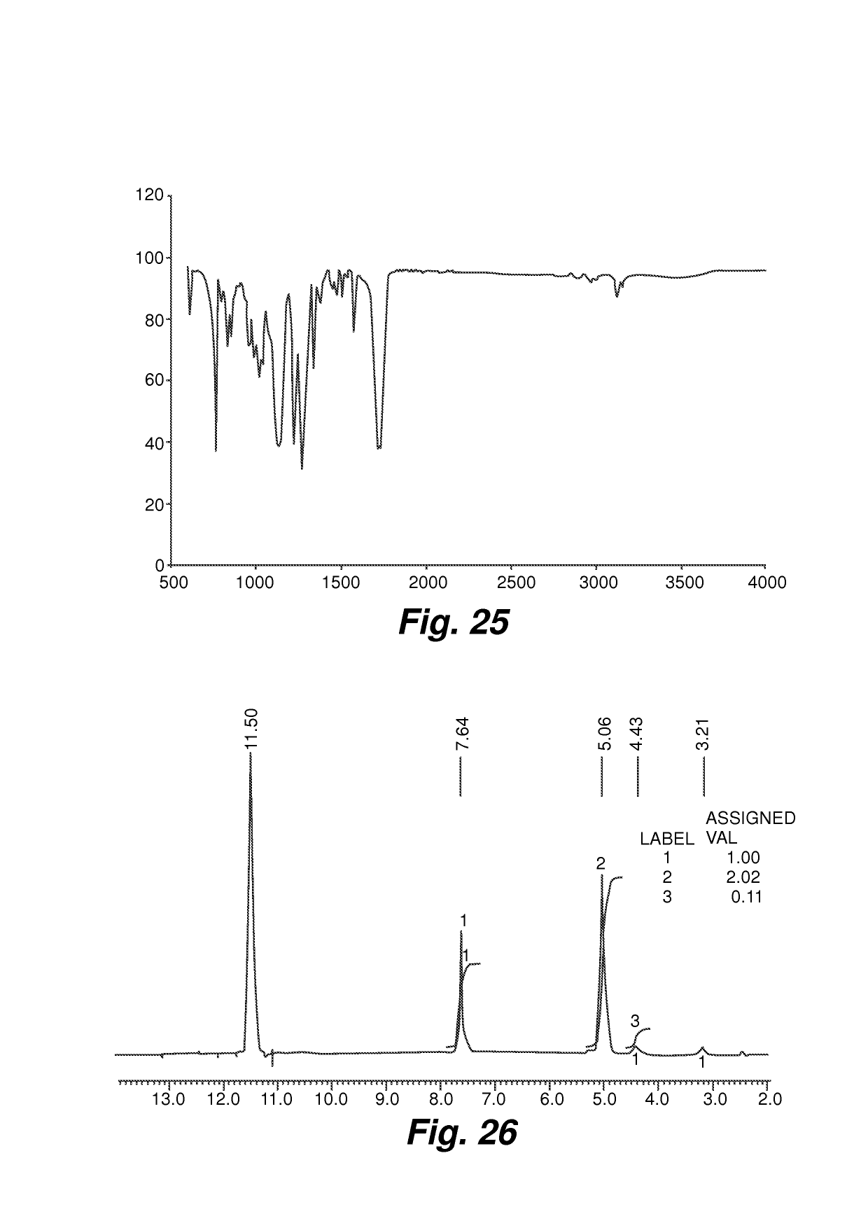

FIG. 25 shows the FTIR for PEF. The obtained IR spectrum of the polymer (PEF) by direct polycondensation with the FDCA (2,5-furandicarboxylic acid) is in agreement with the previous PEF polymer obtained with diester monomer. The spectrum shows peaks at 3119, 1574, 1013, 955, 831, and 779 cm⁻¹, corresponding to 2,5-disubstituted furanic rings. The C═O ester corresponding peak and the C—O stretching bands are found at 1714 and 1264 cm⁻¹. It therefore can be confirmed that there the acid was fully converted to the polymer, since there was no more acid detected. Also the peak at 1129 cm⁻¹, which is the characteristic of the asymmetric vibration of C—O—C (ether), according to the literature, is attributed to the formation of an ether link between terminal OH groups and/or could be assigned to C—O—C of the furan ring.

FIG. 26 shows the NMR for PEF in the solvent CF₃COOD. The wider peaks give indication about the formation of high molecular weight of the polymer, as compared to the previous ones. Here from the spectrum, the peaks corresponding to furanic H3 and H4 at ˜δ 7.6 ppm and that of the ester CH₂ at ˜δ 5 ppm are observed with a ratio of integration of 1:2.

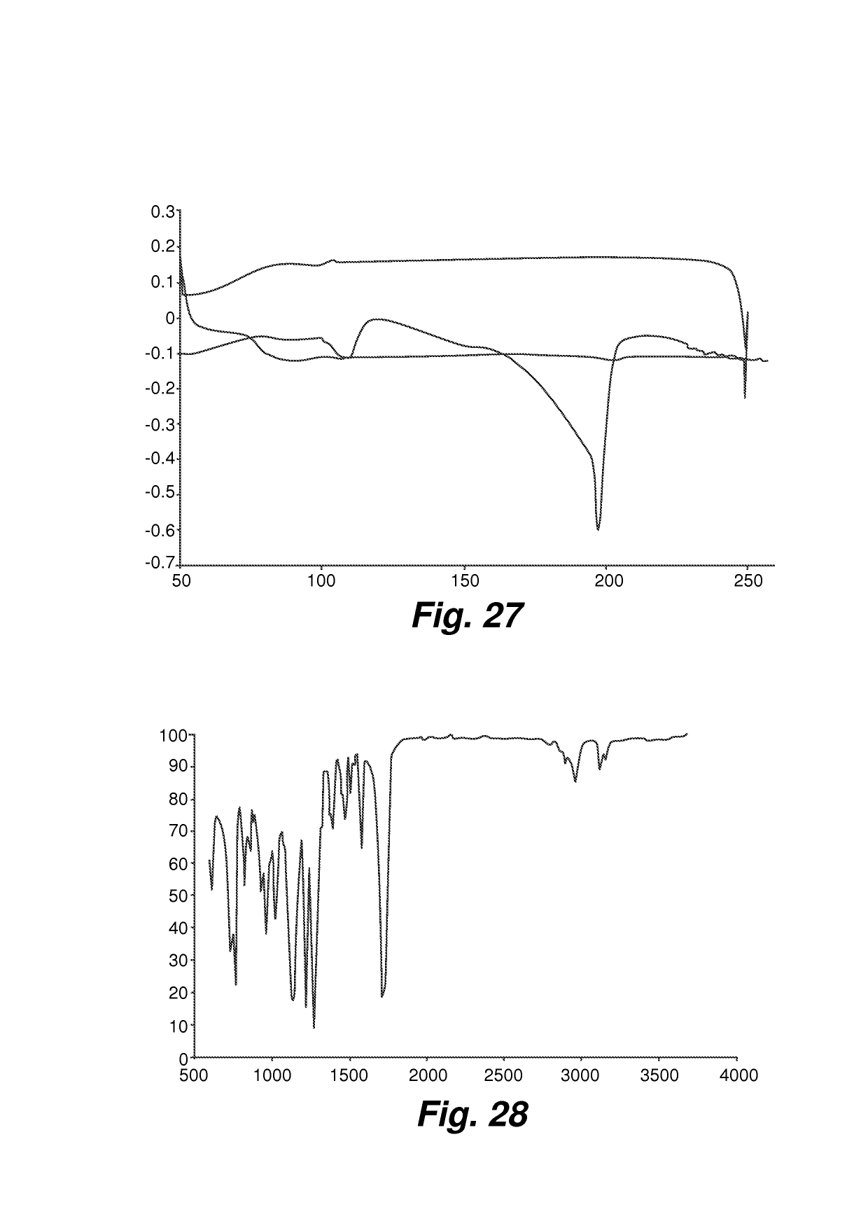

FIG. 27 shows the DSC for PEF. The DSC protocol is the following:

(1) Heating step from 50° to 260° C. at 10° C./min

(2) Isothermal for 5 min

(3) Cooling step 260° to 50° at 10° C./min

(4) Isothermal for 5 min

(5) Second heating step 50° to 260° C. at 10° C./min.

From the DSC curves, it is found that the Tₘ (˜204° C.) and T_{g} (˜79° C.), which is very close value to the PEF polymer (Tₘ˜212° C.) synthesized by polytransesterification using the diester monomer and ethylene glycol, thus confirming the similar characteristics between the two polymers. Thus, this indicates that these polymers have very similar structures.

Poly(butylene 2,5-furandicarboxylate) (PBF)

FIG. 28 shows the FTIR for PBF. It agrees with the previous result obtained (i.e., the PBF synthesized from polytransesterifiation). The spectrum shows peaks at 3115, 1574, 1018, 965, 821, and 769 cm⁻¹, corresponding to 2,5-disubstituted furanic rings. The C═O ester corresponding band and the C—O stretching bands are found at 1710 and 1269 cm⁻¹. Thus, the diacid was fully converted to the polymer. The 2959 cm⁻¹ peak is due to the asymmetric stretching of the methylene groups, while the symmetric stretching of the methylene groups causes the appearance of a weaker peak at 2892 cm⁻¹ peak. Also, the peak at 1127 cm⁻¹, which is the characteristic of the asymmetric vibration of COC ether, is observed. It is worth to mention that in all the polyesters containing furan ring, the corresponding FTIR spectra displayed the presence of a band at around 1020-1050 cm⁻¹, which corresponds to ring breathing and witnesses about the preservation of this heterocycle. Thus, during the synthesis at high temperature furanic ring does not suffer any degradation (ring opening and/or C₃ or C₄ substitution).

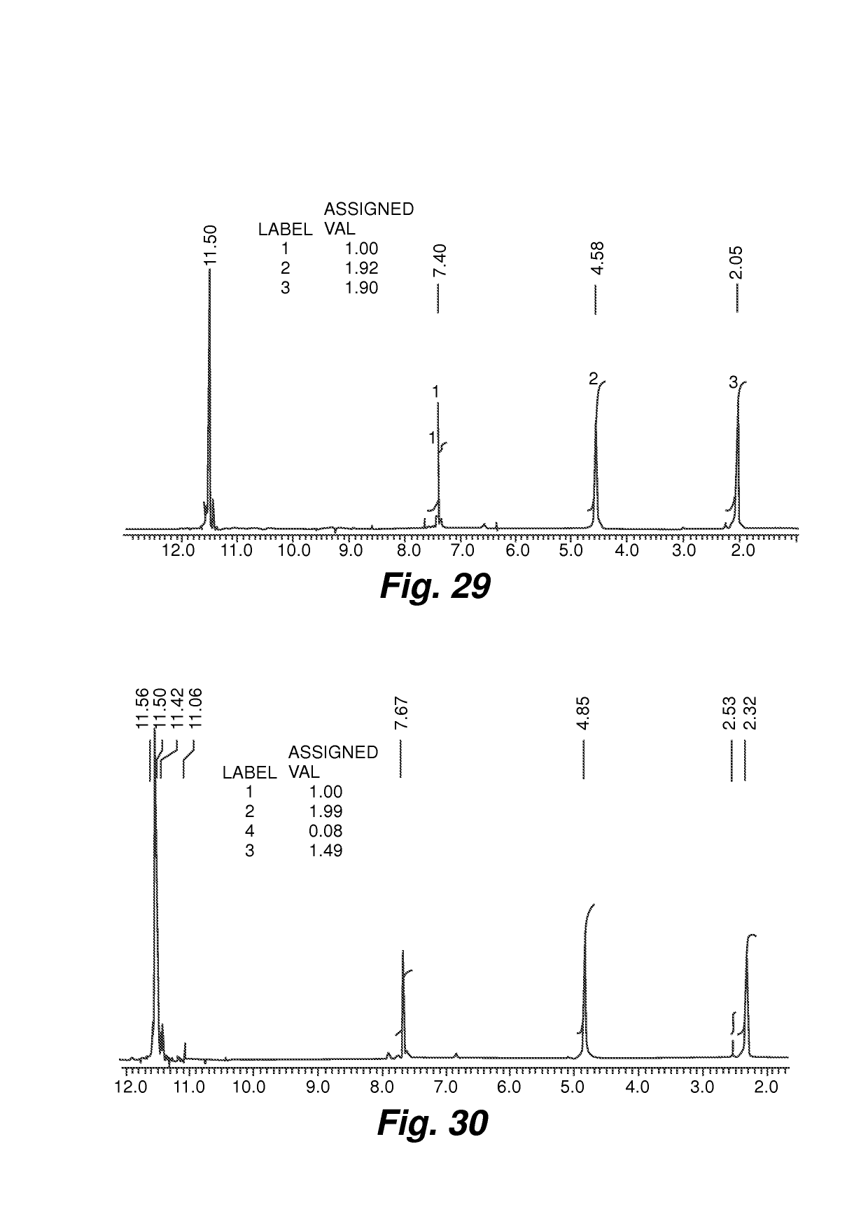

FIGS. 29 and 30 show the NMR for PBF in the solvent CF₃COOD. From the NMR spectra of PBF, the synthesis of PBF is confirmed from the corresponding peaks at δ=7.67 ppm for the H3 and H4 protons of the furanic ring; δ=4.85 ppm for the α CH₂; and δ=2.5 ppm for the β CH₂ protons. Here, the integral values are in good ratio as compared to PBF synthesized by polytransesterification.

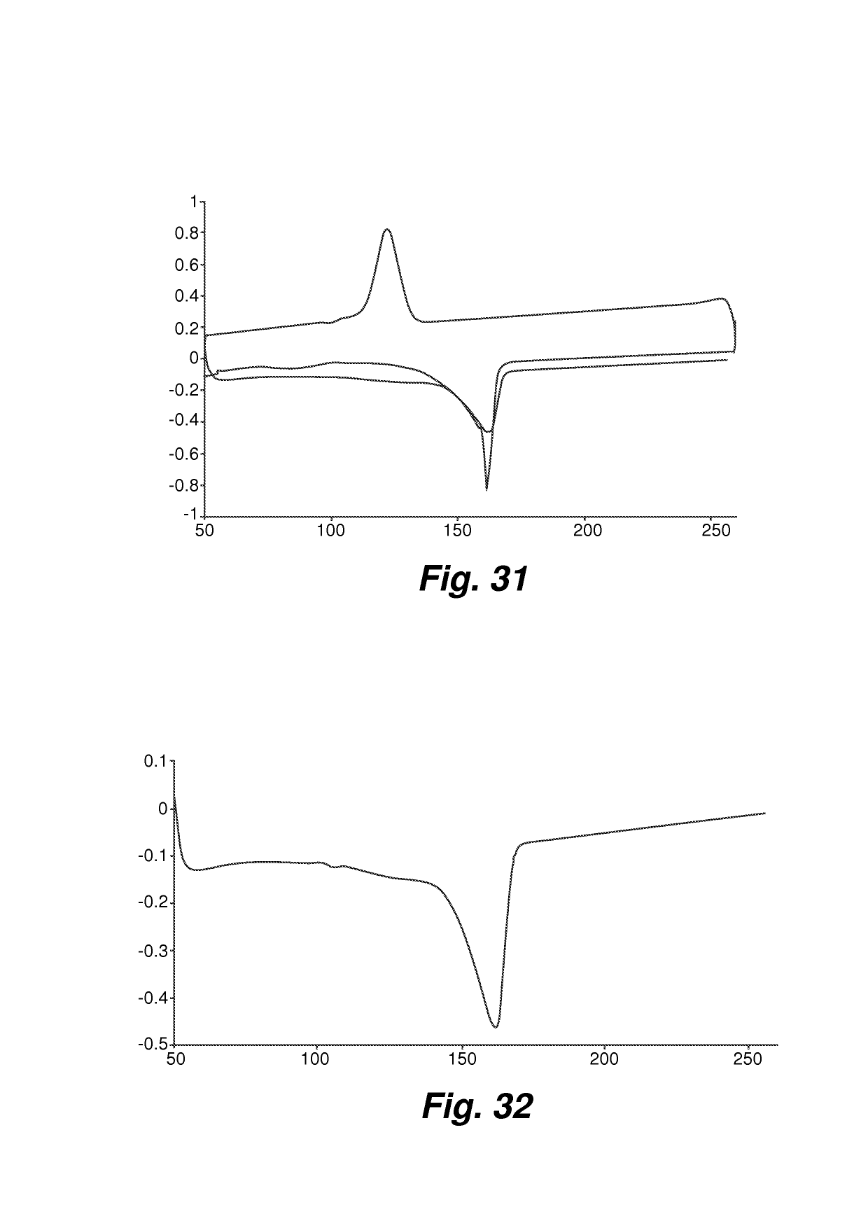

FIGS. 31 and 32 show the DSC for PBF. FIG. 31 shows the full thermodiagram of PBF; and FIG. 32 shows the second heating step. The DSC protocol used is given below.

(1) Heating step from 50° to 260° C. at 10° C./min

(2) Isothermal for 5 min

(3) Cooling step from 260° to 50° C. at 10° C./min

(4) Isothermal for 5 min

(5) Second heating step from 50° to 260° C. at 10° C./min

(6) 3rd step (Heating step from 50° to 250° C. at 10° C./min).

From the DSC curve, better peaks are observed as compared to PBF synthesized by polytransesterification. A melting temperature Tₘ at 163° C., and a T_{g} at ˜104° C. Also, a crystallization exotherm at 121° C. was observed.

Polyester from Isosorbide (PIF)

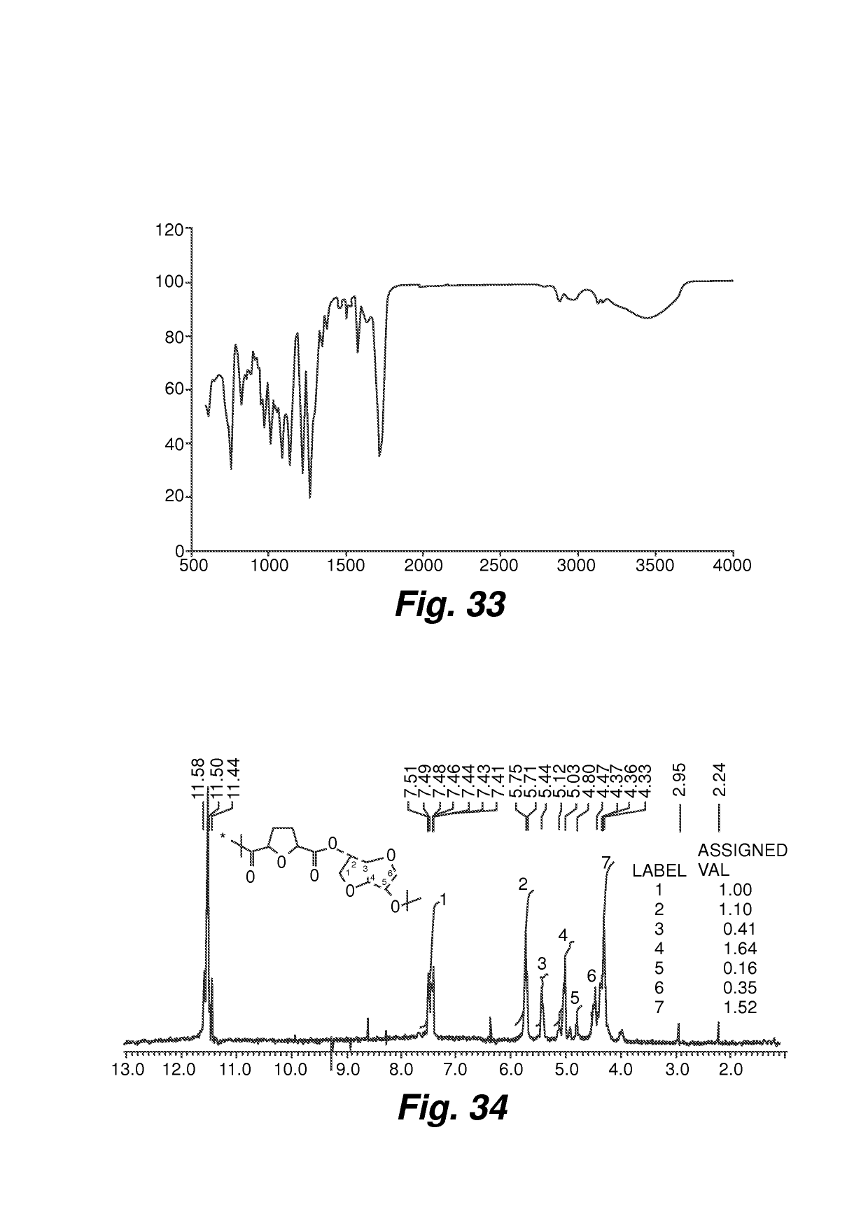

FIG. 33 shows the FTIR for PIF. The IR spectra give a peak at ˜3400 cm⁻¹, which corresponds to the OH elongation. This spectrum shows also that may be some by-products have been formed during the synthesis at higher temperature or some residual water is still present in the medium.

FIG. 34 shows the NMR for PIF in the solvent CF₃COOD. From the NMR spectra, the synthesis of PIF is confirmed by the presence of several peaks: δ=7.67 ppm for the H3 an H4 protons of the furanic ring; δ=5.75 ppm for the 1H (H5); δ=5.44 ppm for the 1H (H2); δ=5.12 ppm for the (H3); δ=4.8 ppm for the (H4); δ=4.47 ppm; and 4.33 ppm corresponding to the two protons at H6 and H1. The integral values are not in good ratios.

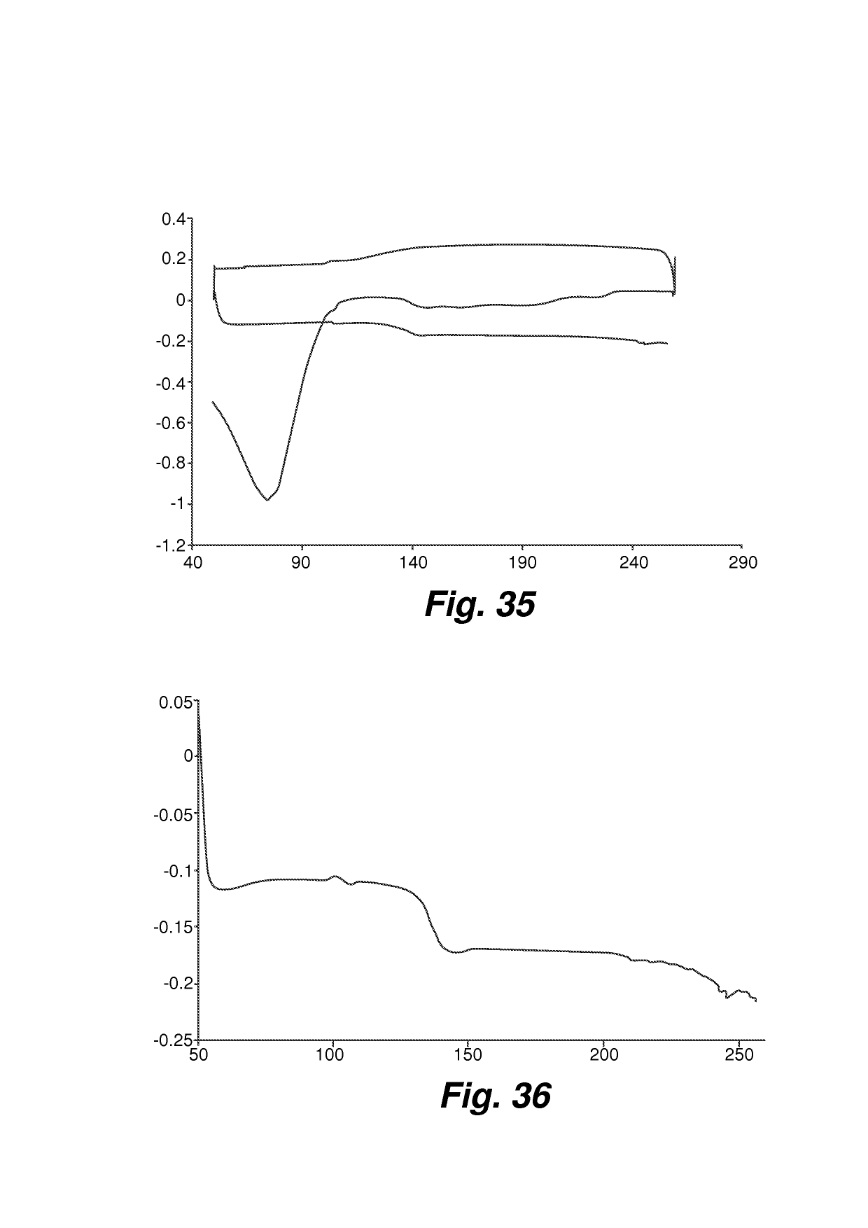

FIGS. 35 and 36 show the DSC for PIF. FIG. 35 shows the full thermodiagram of PIF; and FIG. 36 shows the second heating step. The DSC protocol used is given below.

(1) Heating step from 50° to 260° C. at 10° C./min isothermal for 5 min

(2) Cooling step 260° to 50° at 10° C./min

(3) Isothermal for 5 min

(4) Heating step from 50° to 260° C. at 10° C./min

(5) 3rd step: Ramp 50° C.-260° C. at 10° C./min.

The PIF obtained by direct polycondensation gives a T_{g} at ˜137° C., which approximately agrees with the literature values, in which another synthesis method is used.

Poly(2,5-furandimethylene adipate) (PFA)

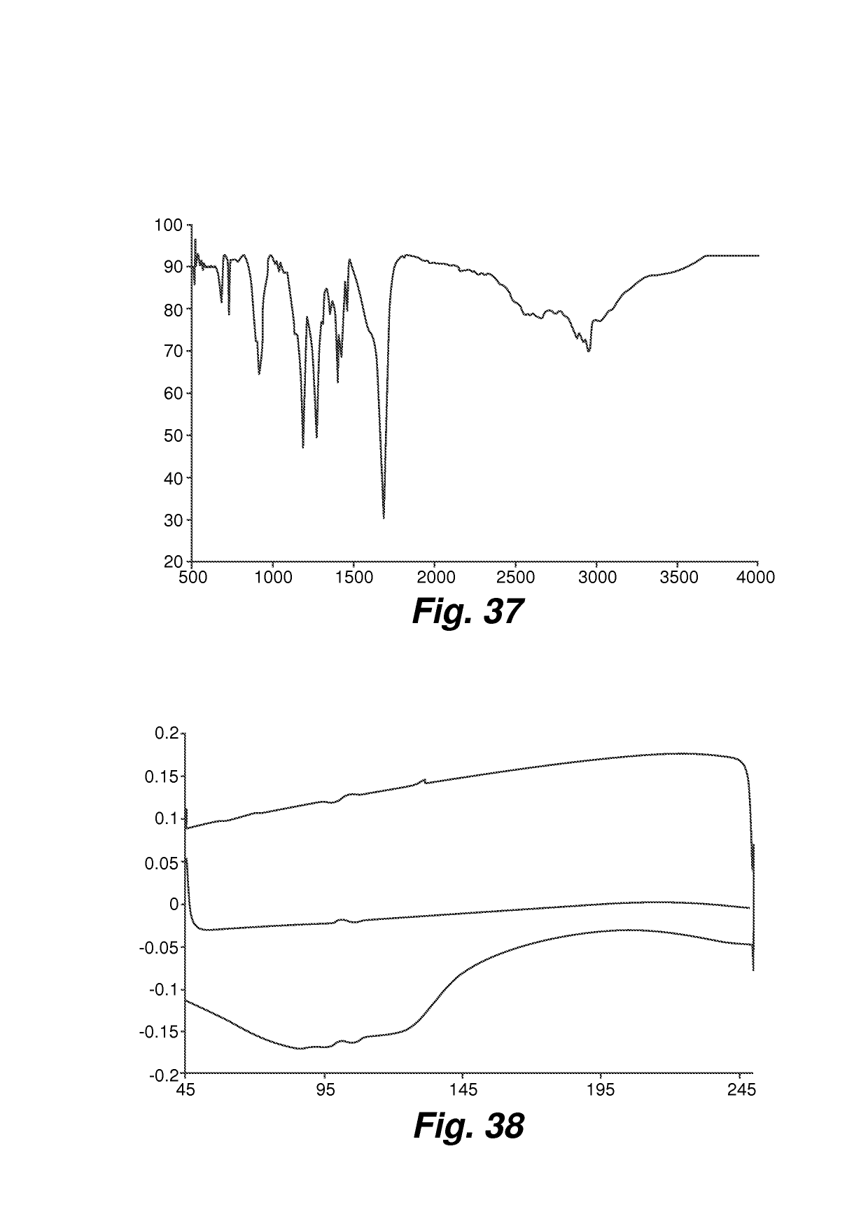

FIG. 37 shows the FTIR for PFA. The spectrum shows peaks at 920, 733 cm⁻¹, corresponding to 2,5-disubstituted furanic rings. The C═O ester corresponding band and the C—O stretching signal are detected at 1687 and 1274 cm⁻¹, respectively. The 2946 cm⁻¹ peak is due to the asymmetric stretching of the methylene groups, while the symmetric stretching of the methylene functions causes the appearance of a weaker signal at 2648 cm⁻¹. The peak at 1190 cm⁻¹ is attributed to the asymmetric vibration of COC ether.

The polymer obtained was char-like and not soluble in any solvents.

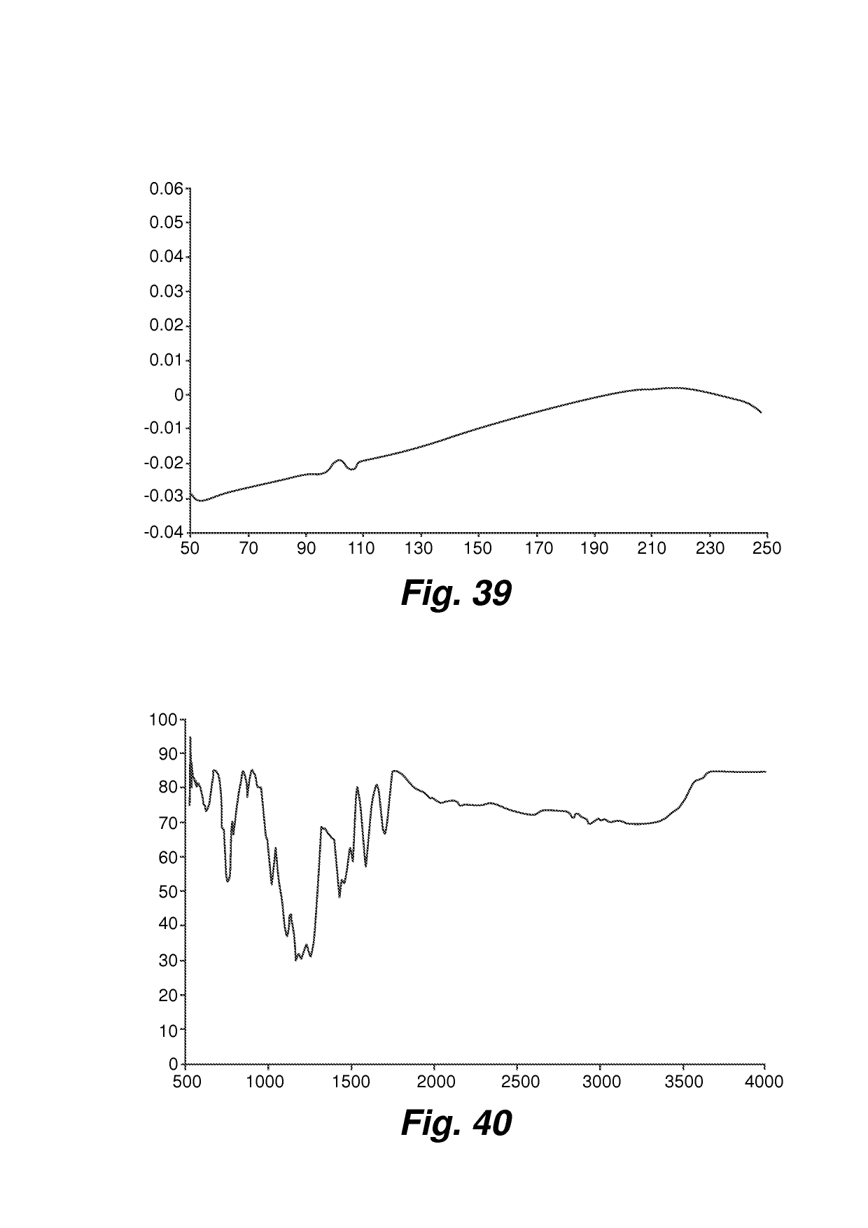

FIGS. 38 and 39 show the DSC for PFA. The protocol was as follows.

(1) Heating step from 45 to 250° C. with a rate of 5° C./min

(2) Isothermal for 5 min

(3) Cooling step from 250 to 45° C. with a rate of 5° C./min

(4) Isothermal for 5 min

(5) Heating step from 50 to 250° C. with a rate of 5° C./min

(6) 3^{rd} step (Ramp 45-250° C. at 5° C./min) (FIG. 39).

From the DSC thermogram, in the first heating step, a broad peak at around 100° C. is observed, which is due to the evaporation of water. In the 3^{rd} step, only a small peak in the same temperature region (100° C.) is observed. This peak is exothermic. It could be assigned to the crystallisation of some polymer fraction, although the amount of this fraction seems to be very low.

Polyvanillic Ester (PVE)

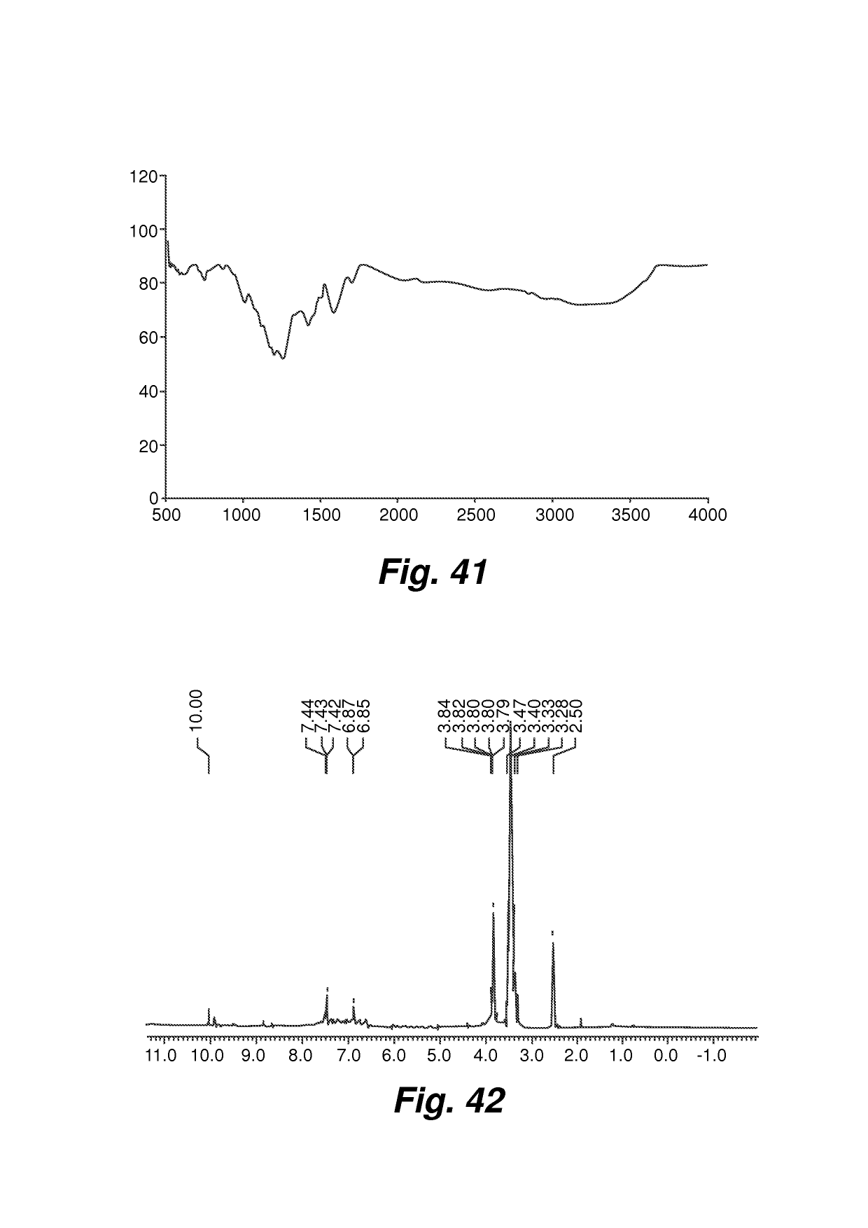

FIG. 40 shows the FTIR for PVE collected directly after synthesis. FIG. 41 shows the FTIR for PVE after purification. Comparing the two spectra, that of the polymer that directly recovered after the synthesis gives a better resolution compared to the “precipitated” second one. The first spectrum shows a broad peak at 3280 cm⁻¹, corresponding to the OH elongation, two small peaks at 2929 and 2832 cm⁻¹ which is attributed to CH asymmetrical and symmetrical stretching, respectively. The peak at 1693 and 1248 cm⁻¹ are assigned to C—O stretching bands characteristics of C═O ester. The peak 1110 cm⁻¹ is related to the C—O—C asymmetric vibration. But, in both spectra, the peaks are not well defined, especially in the second one.

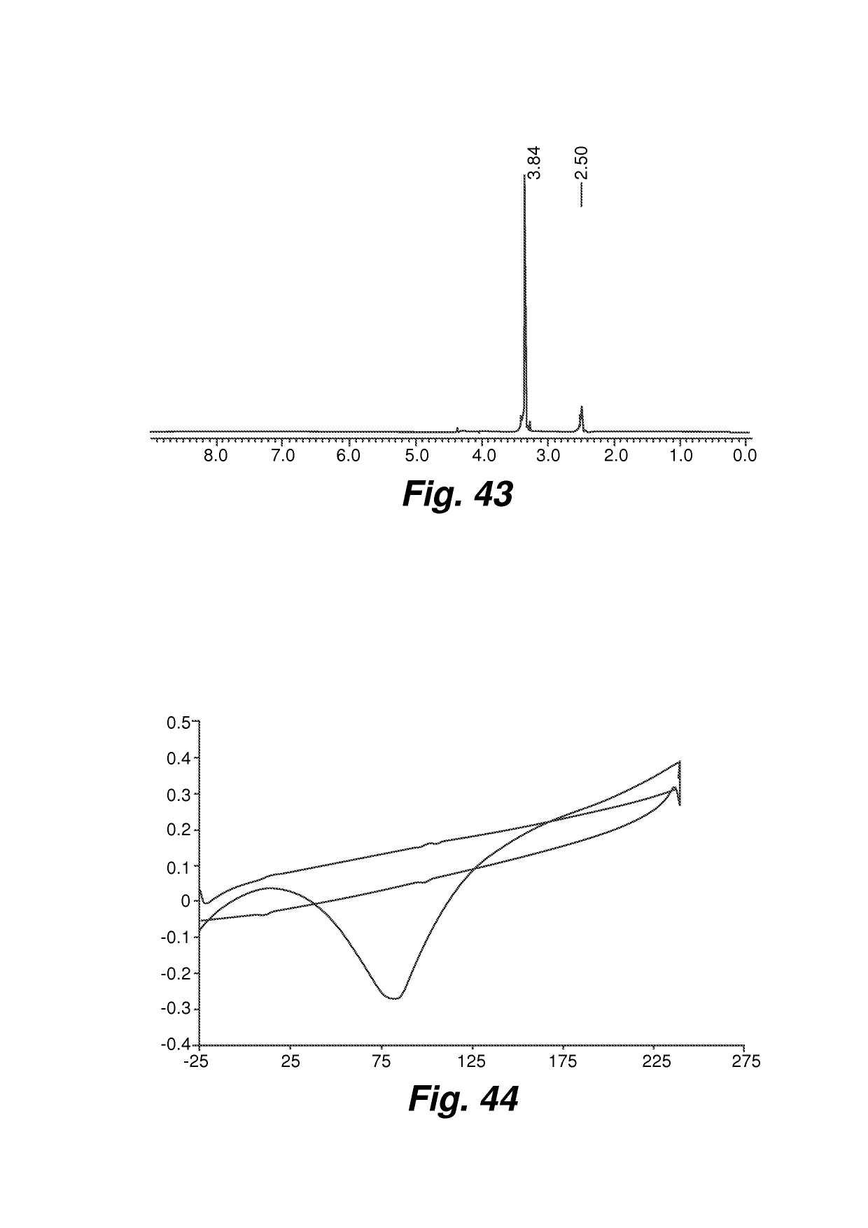

FIG. 42 shows the NMR for PVE collected directly after synthesis in the solvent DMSO. FIG. 43 shows the NMR for PVE after purification in the solvent DMSO. The NMR spectra of PVE before purification shows some peaks at δ=7.4 ppm and 6.87 ppm. But these peaks are very weak and also no integrals correspond to these peaks. PVE after purification shows peaks corresponds only to the solvents. Thus no corresponding peaks of PVE were observed from the NMR spectra, probably because of the very low solubility of the tested polymer.

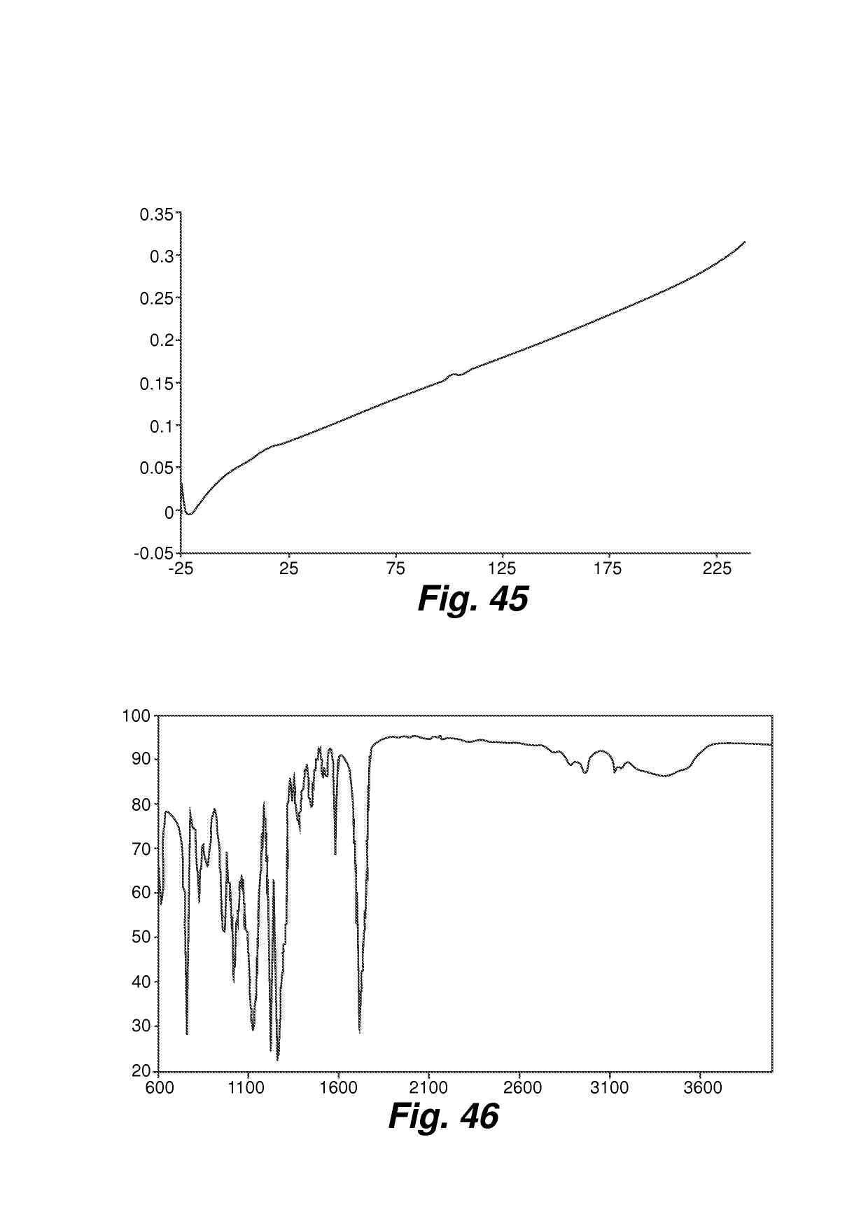

FIGS. 44 and 45 show the DSC for PVE. FIG. 44 shows the full thermodiagram of PVE; and FIG. 45 shows the second heating step. The following protocol was used.

(1) Ramp 5° C./min −25 to 240° C.

(2) Isothermal for 5 min

(3) Ramp 5° C./min 240 to −25° C.

(4) Isothermal for 5 min

(5) Ramp 5° C./min −25 to 240° C.

(6) 3^{rd} step (Ramp −25° C. to 250° C. at 5° C./min).

From the DSC curves, in the first heating step a peak at ˜100° C. is observed, this can be due to water evaporation.

Copolyesters

FIG. 46 shows the FTIR for PEIF. The FTIR spectra obtained shows peaks at 3400, 3115, 2936, 1710, 1575, 1261, 1128, 957, 820, and 759 cm⁻¹. The peaks at 3115, 1575, 1010, 957, 820, 759 cm⁻¹ correspond to 2,5-disubstituted furanic rings. The C═O ester is attributed band and the C—O stretching bands are found at 1710 and 1261 cm⁻¹. The 2936 cm⁻¹ peak is due to the asymmetric stretching of the methylene groups, while the symmetric stretching of the methylene functions causes the weaker 2868 cm⁻¹ peak. The peak at 1128 cm⁻¹ is attributed to the asymmetric vibration of COC ether. As from the resulting peaks, it shows the diacids are converted (peaks at 1710 and 1261 cm⁻¹), while the peak at 3400 cm⁻¹ could be due to the presence of water in the polymer.

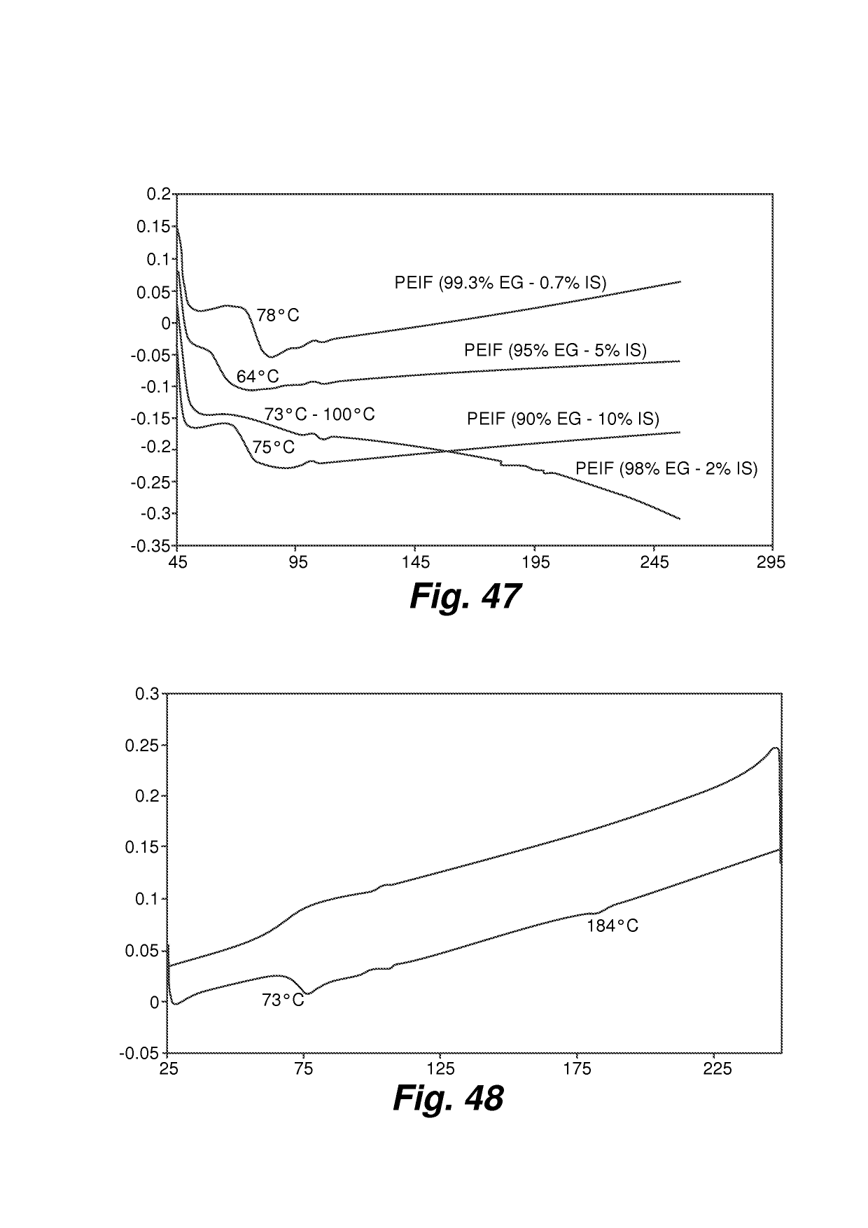

FIGS. 47 show the DSC for PEIF. The following protocol was used:

(1) Ramp 5° C./min 45 to 260° C.

(2) Isothermal for 5 min

(3) Ramp 5° C./min 260 to 45° C.

(4) Isothermal for 5 min

(5) Ramp 5° C./min 45 to 260° C.

The DSC thermogram obtained for the copolyesters is shown in FIG. 47. The thermogram shows that as isosorbide is increased, there is an increase in Tg, followed by a decrease. Also observed was a melting point at 184° C. for the copolyester with 10% isosorbide, as shown in FIG. 48.

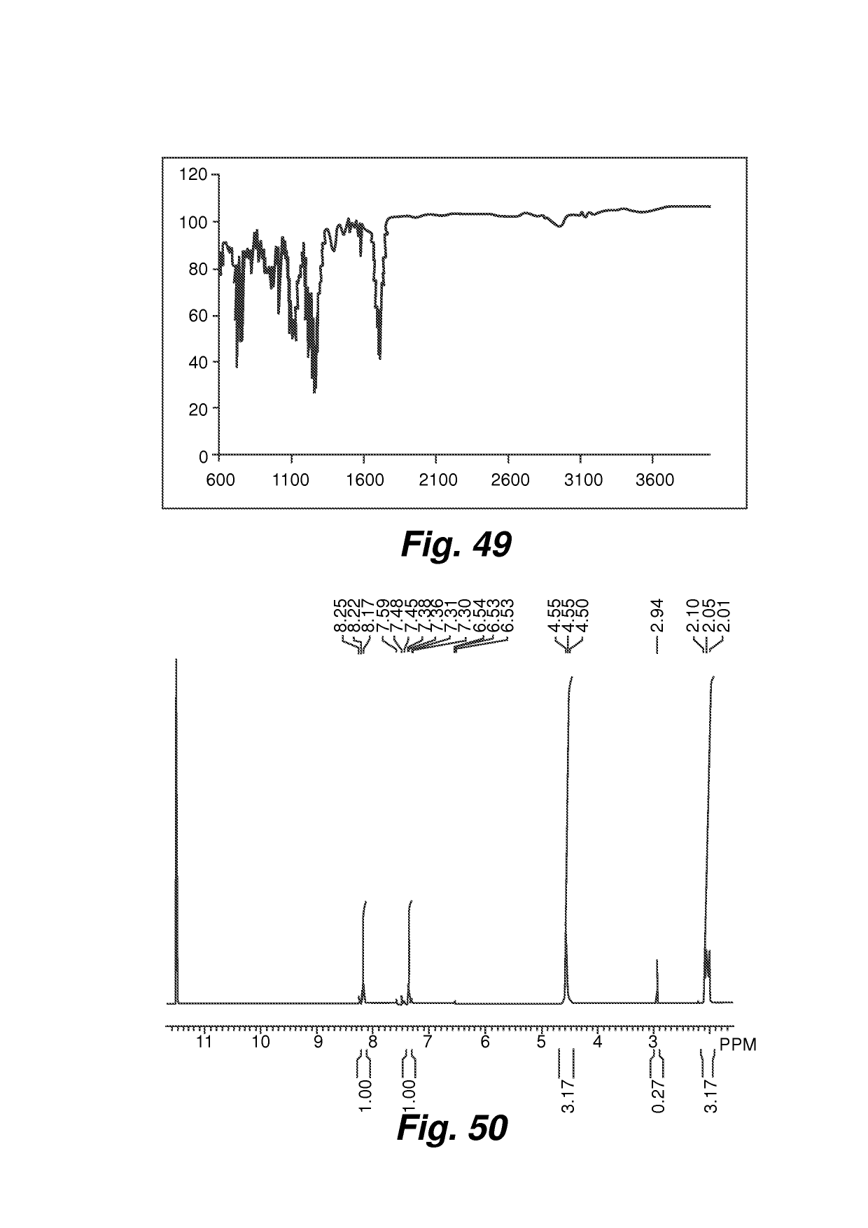

FIG. 49 shows the FTIR for PBTF, and FIG. 50 shows the NMR for PBTF. NMR spectrum gives peaks at δ=8.2 ppm which corresponds to the aromatic ring of terephthalic acid, 7.38 ppm which corresponds to furanic ring, 4.5 ppm for the α CH₂, and 2.1 ppm for the β CH₂ group with the corresponding integration of 1:1:3:3. From this it can be seen that the ratio of the monomer block in the copolyester is 2 furan rings for one terephthalate group.

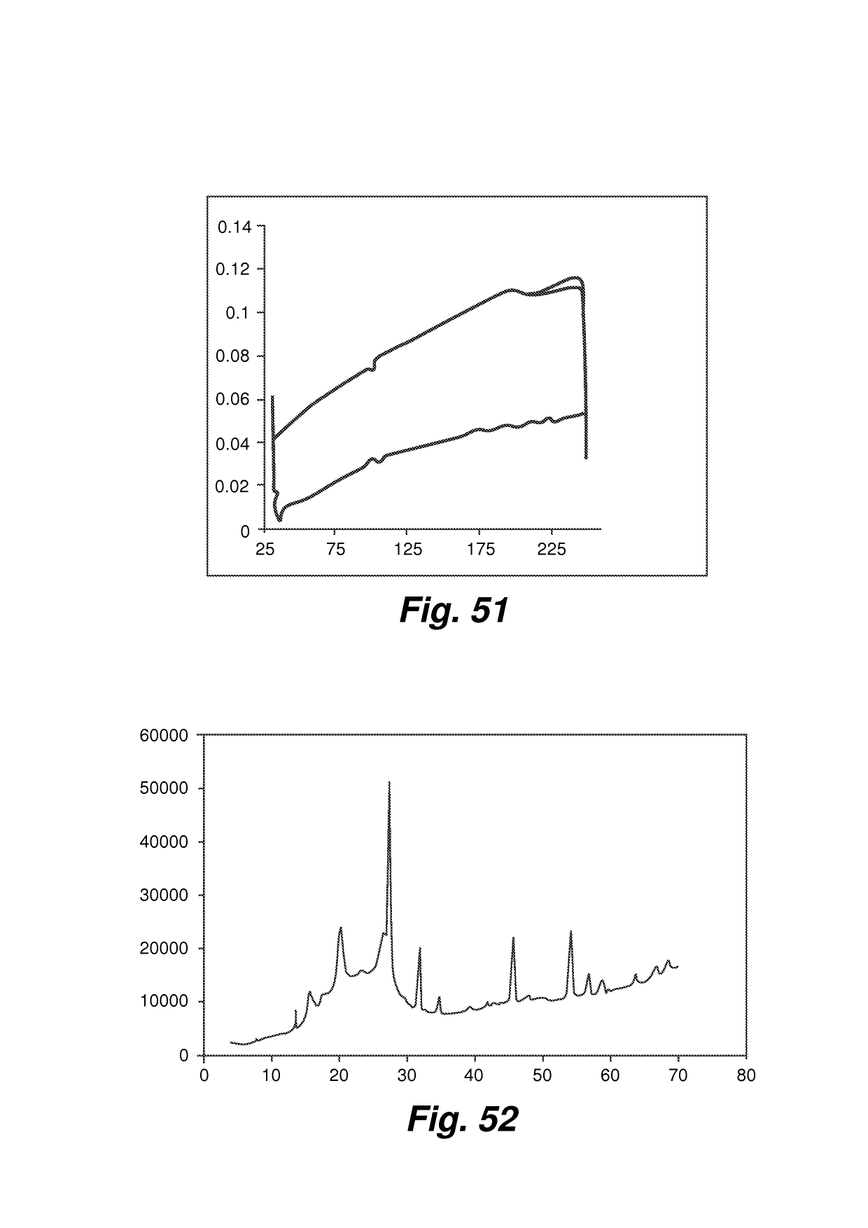

FIG. 51 shows the DSC for PBTF. The DSC thermogram shows no peaks corresponding to the thermal properties of the polymer.

The other characteristics of the polymers and copolymers like thermal degradation properties, molar mass and also the crystallinity of the polymers are discussed below.

Table 1 shows decomposition temperature and onset temperature for the polymers:

TABLE 1

| | Decomposition | Onset temperature |
|---|---|---|
| Polymer | temperature (T_{d}) ° C. | (T_{di}) ° C. |
| PEF | 384 | 355 |
| PBF | 374 | 330 |
| PIF | 395 | 350 |
| PFA | 340 | 305 |
| PVE | — | — |
| PEIF | 380 | 335 |
| PBTF | 390 | 330 |

The above values show that all the polymers obtained have good thermal properties. Values for PEF and PBF agree with the values obtained for the synthetic polymers.

Molecular weight calculations were performed on the three polymers PEF, PBF, and PEIF. The results obtained from the SEC-MALLS analysis is shown in Table 2 below.

TABLE 2

| | MALLS calibration | | | |
|---|---|---|---|---|
| | Mw | Mn | dn/dc | |
| Sample | (g/mol) | (g/mol) | (mg/ml) | DPn |
| PEF | 16500 | 5200 | 0.233 | 29 |
| PBF | 159000 | 47750 | ND | 228 |
| PEIF | 86500 | 17400 | ND | 56 |

FIGS. 52-55 show the results of x-ray diffraction (XRD) for the polymers. The degree of crystallinity of each polymer was calculated using the equation:

Xc=[Ac/(Ac+Aa)]×100

FIG. 52 shows the results of x-ray diffraction (XRD) for PEF. The degree of crystallinity obtained was 40-50%.

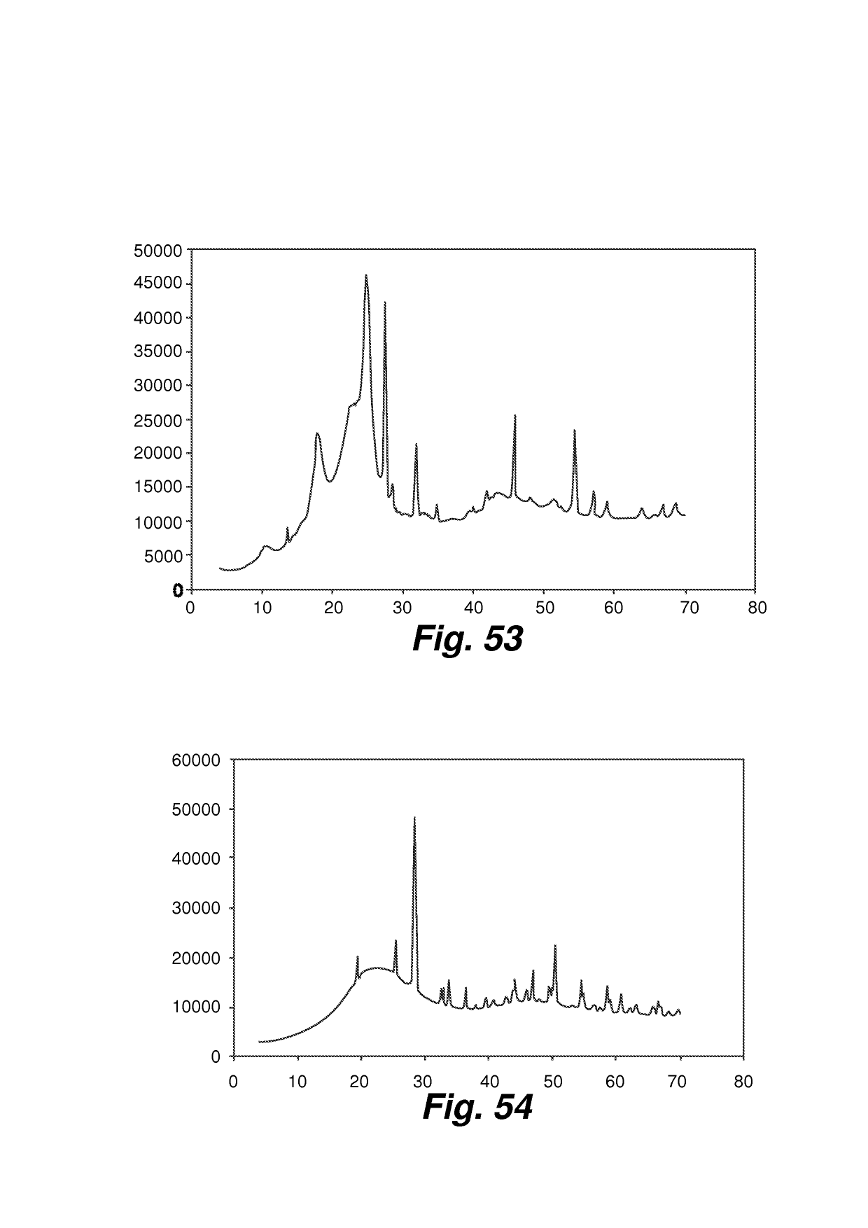

FIG. 53 shows the results of XRD for PBF. The degree of crystallinity obtained was 30-40%.

FIG. 54 shows the results of XRD for PEIF. The degree of crystallinity obtained was 20-25%.

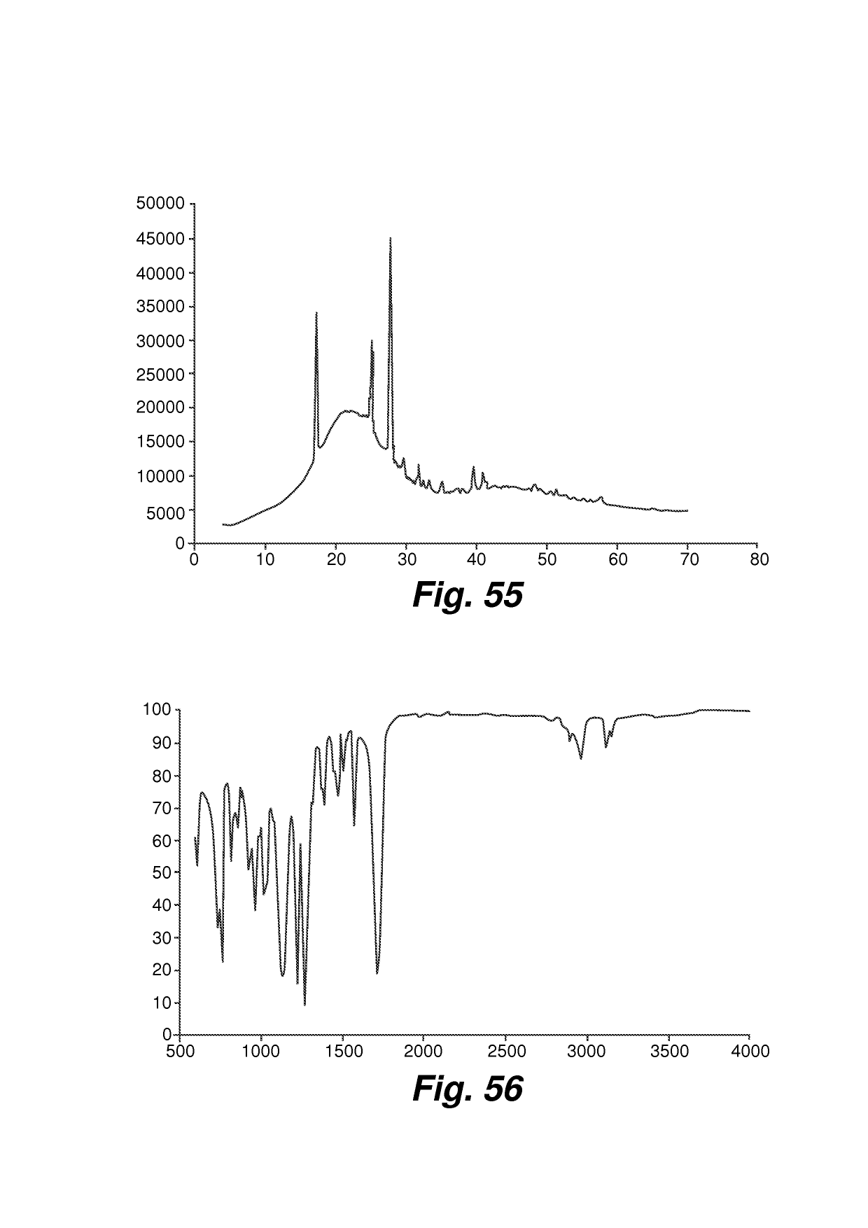

FIG. 55 shows the results of XRD for PBTF. The degree of crystallinity obtained was 17-20%.

From the above results, it was found that the copolyesters are essentially amorphous polymers. The value obtained for PEF and PBF are close to the values of PET and PBT.

Density

Densities of the polymers were measured using a glass pycnometer. The method used is as described below:

The weight of the empty pycnometer was measured. Then ⅓ of the pycnometer was filled with the polymer and the weight measured. Then water was added so that the capillary hole in the stopper is filled with water and measured weight. Then the pycnometer was emptied and then weighed by adding water. Based on the known density of water, its volume can be calculated. Then, the mass and volume of the object was calculated to determine the density. Table 3 below gives the density of the polymers and their degrees of crystallinity.

TABLE 3

| | | Degree of |
|---|---|---|
| | Density | Crystallinity |
| Polymer | (g/cm³) | (%) |
| PET (synthesized) | 1.35 | 54 |
| PEF | 1.39 | 45-50 |
| PBF | 1.40 | 30-40 |
| PEIF | 1.38 | 20-25 |
| PBTF | 1.37 | 17-20 |

The following table summarizes T_{g}, T_{c}, and Tₘ for the polyesters PEF, PBF-a, PBF-b, and PEIF.

TABLE 4

| Polyester | T_{g} (° C.) | T_{c} (° C.) | Tₘ (° C.) |
|---|---|---|---|
| PEF | 79 | — | 203 |
| PBF-a | 105 | 121 | 163 |
| PBF-b | 105 | 120 | 161 |
| PEIF | 78 | — | — |

Catalyst Effect

The effect of catalyst in the polymerization is also studied by using imidazole as the catalyst instead of antimony trioxide. The polymer synthesized is PBF using the direct polycondensation method. FIG. 56 shows the FTIR of the resulting polymer. The IR spectrum obtained agrees with that of the PBF synthesized using antimony trioxide as the catalyst.

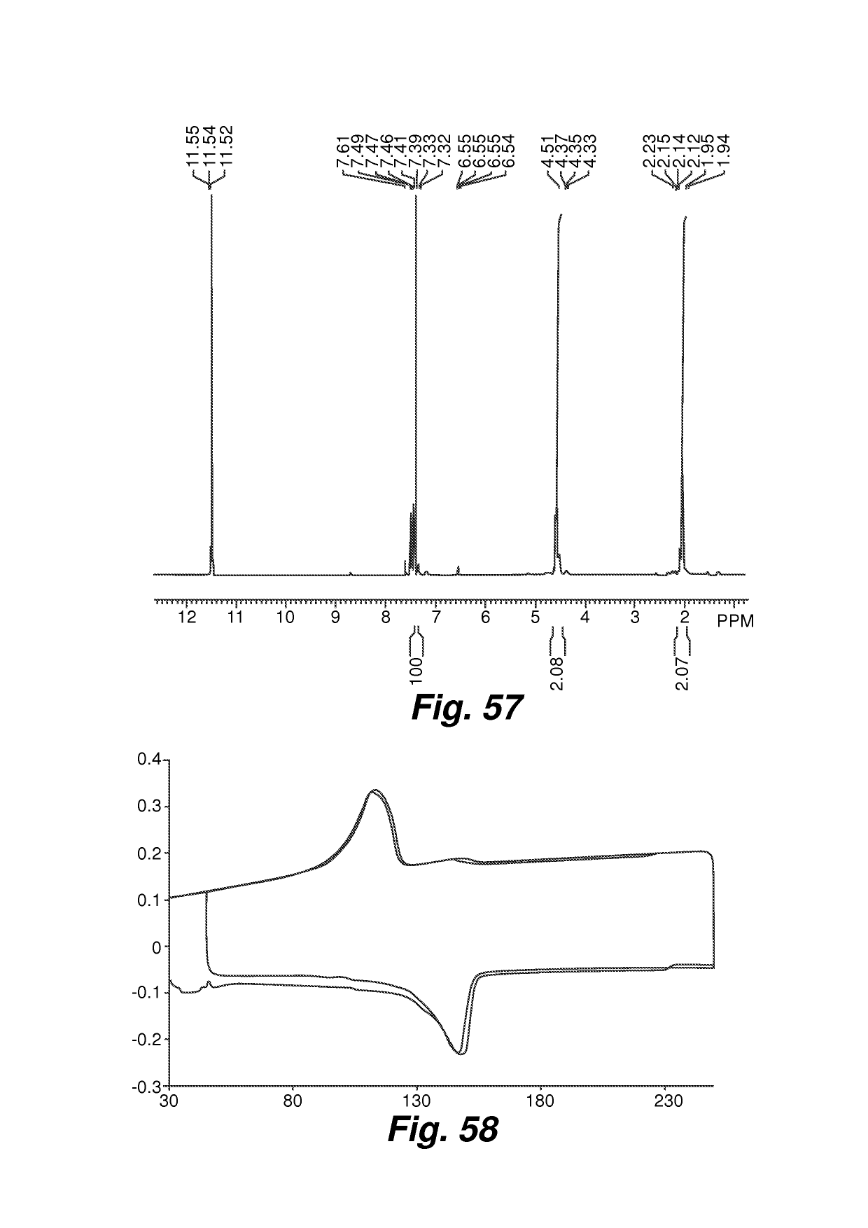

FIG. 57 shows the NMR for the polymer (Solvent: CF₃COOD). From the NMR spectra, the synthesis of PBF is confirmed from the corresponding peak at: δ=7.47 ppm for the H3 and H4 protons of the furanic ring; δ=4.51 ppm for the α CH₂ and δ=2.15 ppm for the β CH₂ protons. Here the integral values are in good ratio as compared to PBF.

FIG. 58 shows the DSC for the polymer. Observed from the DSC thermogram were a Tg at 101° C., Tm at 150° C. and Tc of 113° C. As compared with the PBF using antimony as the catalyst, there was ˜10° C. less in Tc and Tm. Thus it is possible to obtain a polymer with different Tm values by the use of a different catalyst.

Scaling-up Trials

The scaling-up trials concerning the polymer syntheses were successful for PET and PEF and PBF. These polymers were prepared and characterized. The FTIR spectra and the DSC tracings show that these polymers are similar to those prepared previously. It is worth to note that in these trials, the reaction time is shorter. This could provide more efficient and cost effective methods for synthesizing the polymers.

The foregoing description should be considered illustrative rather than limiting. It should be recognized that various modifications can be made without departing from the spirit or scope of the invention as described and claimed herein.

What is claimed is:

1. A copolyester formed from monomers of (i) 2,5-furandicarboxylic acid, or a lower alkyl ester thereof, (ii) at least one aliphatic or cycloaliphatic C₃-C₁₀ diol, and (iii) terephthalic acid.

2. The copolyester of claim 1 wherein the at least one diol is selected from the group consisting of 1,4-butanediol, isosorbide, and combinations thereof.

3. The copolyester of claim 1 wherein the monomers further comprise (iv) ethylene glycol.

4. The copolyester of claim 1 wherein the at least one diol is 1,4-butanediol.

5. The copolyester of claim 1 wherein the at least one diol is isosorbide.

6. An article comprising the copolyester of claim 1.

7. The article of claim 6 which is a food package.

8. The article of claim 6 which is a beverage container.

9. A polyester formed from monomers of 2,5-furan dicarboxylic acid, or a lower alkyl ester thereof, and isosorbide.

10. A polyester selected from the group consisting of poly(2,5-furandimethylene adipate), polyvanillic ester, and polyethylene isosorbide furandicarboxylate.

11. An article comprising the polyester of claim 10.

12. The article of claim 11 which is a food package.

13. The article of claim 11 which is a beverage container.

14. A method of preparing a 2,5-furandicarboxylic acid based copolyester, the method comprising:
combining 2,5-furandicarboxylic acid or a lower alkyl ester thereof, at least one aliphatic or cycloaliphatic C₂-C₁₀ diol, terephthalic acid, and a catalyst to form a reaction mixture;
stirring the reaction mixture under a stream of nitrogen;
gradually heating the reaction mixture to a first temperature of about 200-230° C. and maintaining the first temperature for about 8 to about 12 hours;
gradually heating the reaction mixture to a second temperature of about 240-260° C. and maintaining the second temperature for about 12 to about 18 hours;
removing water from the reaction mixture; and
collecting the resulting copolyester.

15. The method of claim 14 wherein the at least one diol is selected from the group consisting of ethylene glycol, 1,4-butanediol, isosorbide, and combinations thereof.

16. The method of claim 14 wherein the at least one diol is ethylene glycol.

17. The method of claim 14 wherein the at least one diol is 1,4-butanediol.

18. The method of claim 14 wherein the at least one diol is isosorbide.

19. The method of claim 14 wherein the catalyst is an oxide or salt of a metal selected from the group consisting of silicon, aluminum, zirconium, titanium, cobalt, and combinations thereof.

20. The method of claim 14 wherein the catalyst is antimony trioxide.
